(19) United States
(12) Patent Application Publication
(10) Pub. No.: US 2026/0006710 A1
(43) Pub. Date: Jan. 1, 2026

(54) SYSTEMS AND METHODS FOR OPERATING A TORCH BASED ON A PHYSICAL FORMATION OF A TORCH COMPONENT

(71) Applicant: The ESAB Group, Inc., North Bethesda, MD (US)

(72) Inventors: Secundino Miguel Baldonado, Hopkinton, NH (US); Erik Anthony Leger, Newmarket, NH (US); Andrew John Raymond, Lebanon, NH (US); Geoffrey H. Putnam, Charlestown, NH (US)

(21) Appl. No.: 19/249,382

(22) Filed: Jun. 25, 2025

Related U.S. Application Data
(60) Provisional application No. 63/664,317, filed on Jun. 26, 2024.

(51) Int. Cl. H05H 1/36

(52) U.S. Cl. CPC H05H 1/36

(57) ABSTRACT

A torch system includes a torch mount configured to engage with a torch body to form a chamber in an assembled configuration of the torch system, a conduit configured to direct fluid into the chamber, and a processor configured to monitor a pressure in the chamber and transmit a signal in response to determining a difference between a rate of decrease of the pressure in the chamber with an expected rate is above a threshold.

### CROSS-REFERENCE TO RELATED APPLICATION

This application claims priority to and the benefit of U.S. Provisional Patent Application No. 63/664,317, entitled “SYSTEMS AND METHODS FOR OPERATING A TORCH ASSEMBLY BASED ON A PHYSICAL FORMATION OF A CONSUMABLE,” filed Jun. 26, 2024, which is hereby incorporated by reference in its entirety for all purposes.

### TECHNICAL BACKGROUND

The present application generally relates to a torch and, more particularly, techniques for operating a torch based on a physical formation of a torch component implemented in the torch.

### BACKGROUND

Many welding and cutting torches, such as plasma cutting torches, may be implemented with a variety of consumables (e.g., welding tips, cutting tips, and/or a variety of electrodes), as well as other interchangeable torch components. Consequently, a single torch may be used for a variety of cutting and/or welding operations (with different torch bodies, tips, electrodes, and/or other interchangeable/consumable components being installed for different operations). However, different interchangeable torch components (e.g., different torch bodies, torch tips, and/or different electrodes) often utilize different operational settings. Thus, it is desirable to provide the operational settings suitable for operating a torch based on the particular components implemented in the torch.

### SUMMARY

According to an embodiment of the present disclosure, a torch system includes a torch mount configured to engage with a torch body to form a chamber therebetween in an assembled configuration of the torch system, a conduit configured to direct fluid into the chamber, and a processor configured to monitor a pressure in the chamber and transmit a signal in response to determining a difference between a rate of decrease of the pressure in the chamber and an expected rate is above a threshold.

According to another embodiment of the present disclosure, a non-transitory, computer-readable medium includes instructions that, when executed by one or more processors, are configured to cause the one or more processors to monitor a pressure within a chamber formed by engagement between a torch body and a consumable, compare a rate of decrease of the pressure to a target rate, and transmit a signal in response to determining a difference between the rate of decrease of the pressure and the target rate is above a threshold.

According to yet another embodiment of the present disclosure, a torch assembly includes a torch body configured to engage with a consumable. The torch body includes a plurality of pins and a subset of the plurality of pins is configured to translate upon engagement with a physical formation of the consumable. The torch assembly also includes a processor configured to transmit a signal based on a position of the plurality of pins caused by engagement of the torch body with the consumable.

These and other advantages and features will become evident in view of the drawings and detailed description.

### BRIEF DESCRIPTION OF THE DRAWINGS

To complete the description and in order to provide for a better understanding, a set of drawings is provided. The drawings form an integral part of the description and illustrate embodiments of the present application, which should not be interpreted as restricting the scope of the disclosure, but just as examples of how the disclosure can be carried out. The drawings comprise the following figures:

FIG. 1A is a perspective view of an automated cutting system that may execute the techniques presented herein, according to an example embodiment of the present disclosure.

FIG. 1B is perspective view of an automated cutting head that may be included in the automated cutting system illustrated in FIG. 1A, according to an example embodiment of the present disclosure.

FIG. 1C is a schematic, cross-sectional view of an end portion of a plasma torch, according to an example embodiment of the present disclosure.

FIG. 2 is a simplified block diagram of components of a torch system, according to an example embodiment of the present disclosure.

FIG. 3A is a perspective side view of a torch assembly with a consumable component having annular physical formations, according to an example embodiment of the present disclosure.

FIG. 3B is side view of a consumable torch component having annular physical formations, according to an example embodiment of the present disclosure.

FIG. 4A is a top perspective view of a consumable torch component with an extension, according to an example embodiment of the present disclosure.

FIG. 4B is a bottom perspective view of a torch body with a recess configured to receive the extension of the consumable torch component of FIG. 4A, according to an example embodiment of the present disclosure.

FIG. 5A is a top perspective view of a consumable torch component with extensions, according to an example embodiment of the present disclosure.

FIG. 5B is a bottom perspective view of a torch body with pins configured to move upon engagement with the extensions of the consumable torch component of FIG. 5A, according to an example embodiment of the present disclosure.

FIG. 6A is a top perspective view of another consumable torch component with extensions, according to an example embodiment of the present disclosure.

FIG. 6B is a bottom perspective view of a torch body with apertures configured to receive the extensions of the consumable torch component of FIG. 6A, according to an example embodiment of the present disclosure.

FIG. 6C is a schematic diagram of extensions of a consumable torch component positioned within apertures of a torch body, according to an example embodiment of the present disclosure.

FIG. 6D is a top perspective view of a consumable torch component with extensions extending from a textured surface, according to an example embodiment of the present disclosure.

FIG. 6E is a schematic diagram of extensions of a consumable torch component positioned within apertures of a torch body, according to an example embodiment of the present disclosure.

FIG. 7A is a top perspective view of a consumable torch component with apertures, according to an example embodiment of the present disclosure.

FIG. 7B is a bottom perspective view of a torch body with extensions configured to extend into the apertures of the consumable torch component of FIG. 7A, according to an example embodiment of the present disclosure.

FIG. 8A is a top perspective view of a torch body with extensions, according to an example embodiment of the present disclosure.

FIG. 8B is a bottom perspective view of a torch mount with apertures configured to receive the extensions of the torch body of FIG. 8A, according to an example embodiment of the present disclosure.

FIG. 8C is a schematic diagram of extensions of a torch body positioned within apertures of a torch mount, according to an example embodiment of the present disclosure.

FIG. 8D is a top perspective view of a torch body with apertures, according to an example embodiment of the present disclosure.

FIG. 8E is bottom perspective view of a torch mount with extensions configured to extend into the apertures of the torch body of FIG. 8D, according to an example embodiment of the present disclosure.

Each of FIGS. 9-12 is a flowchart of a method for operating a torch system based on engagement between components of the torch system, according to an example embodiment of the present disclosure.

Like reference numerals have been used to identify like elements throughout this disclosure.

### DETAILED DESCRIPTION

The following description is not to be taken in a limiting sense but is given solely for the purpose of describing the broad principles of the present application. Embodiments of the present application will be described by way of example, with reference to the above-mentioned drawings showing elements and results of such embodiments.

The present disclosure is directed to operating a torch (e.g., a torch system) based on engagement between components of the torch, such as a torch mount, a torch body, and/or a consumable. For example, the torch may be used to generate an arc to melt material (e.g., to remove material from a metal workpiece, to weld material onto a metal workpiece). In some embodiments, a component of the torch can be interchangeably used such that one of a plurality of interchangeable components can be selectively implemented in a torch, such as to perform a particular one of different types of operations.

However, each interchangeable component may have different characteristics and, therefore, each interchangeable component may operate most effectively at different operational settings (e.g., different gas flow rates). By way of example, a power supply that provides power to the torch may be adjusted to effectuate appropriate operational settings for an installed interchangeable component. Unfortunately, it can be difficult and/or cumbersome to implement the operational settings suitable for an interchangeable component. As an example, a user may manually identify an interchangeable component, consult reference information (e.g., manuals) to determine the operational settings for the interchangeable component, and manually adjust the power supply to provide the operational settings. Such operation by the user may be tedious, confusing, and/or time-consuming, all of which can negatively affect operation of the torch (e.g., by increasing downtime in which the torch does not operate, such as upon switching interchangeable components from the torch). Additionally or alternatively, the torch can operate under unsuitable operational settings, which may negatively impact cutting/welding performance of the torch and/or decrease part life, each of which may create inefficiencies in welding/cutting operations, in terms of both time and cost.

Embodiments of the present disclosure are directed to using physical formations of an interchangeable component to provide the operational settings for operating a torch assembly of a torch. In some embodiments, the physical formations include circumferential bands. In additional or alternative embodiments, the physical formations include one or more extensions. In further embodiments, the physical formations include a profile or texture (e.g., of a surface). For any of these embodiments, the physical formations provide a particular engagement between components of the torch. As an example, a component may include a receptacle configured to receive a physical formation having a particular shape (e.g., a particular cross-section) and to block insertion of a different physical formation. As another example, a component may include movable pins, and certain pins are configured to move upon engagement with a physical formation. As a further example, a component may include apertures configured to receive a physical formation to form a chamber configured to receive fluid to pressurize the chamber. The particular engagement with the component establishes a certain rate of pressure decay within the chamber caused by fluid flow out of the chamber.

In any case, the engagement provided by an interchangeable component via the physical formation is determined, and a further operation is performed as a result. For instance, in response to a determination that the provided engagement is not desirable, which may indicate that an interchangeable component embodiment is not desirable (e.g., the interchangeable component does not have a desirable physical formation), operation of the torch assembly may be suspended or blocked to avoid negatively affecting operation and/or a structural integrity of the torch assembly that otherwise may occur as a result of operating the torch assembly while a interchangeable component embodiment is undesirably engaged with the torch body. However, in response to a determination that the provided engagement is desirable, which may indicate that the interchangeable component embodiment is desirable (e.g., the interchangeable component has a physical formation indicating the interchangeable component is genuine), operation of the torch assembly may be enabled. In certain embodiments, a particular operating parameter or setting suitable for operating the interchangeable component is also determined based on an engagement between the torch body and the interchangeable component. For instance, different interchangeable component embodiments may provide different engagements with the torch body and may be configured to operate according to different operating parameters. Thus, the particular engagement provided by the interchangeable component via the physical formation indicates the interchangeable component embodiment and, accordingly, the operating parameter suitable for the interchangeable component embodiment.

The present disclosure primarily discusses a particular interchangeable component (e.g., a consumable) having certain physical formations to provide an engagement with another component (e.g., a torch body) of a torch. However, it should be noted that any of the discussed physical formations can be implemented on any other interchangeable component (e.g., the torch body) of the torch to provide a certain engagement for identifying the interchangeable component embodiment being implemented in the torch. As an example, for any of the disclosed embodiments, the features presently discussed with respect to the consumable may additionally or alternatively be implemented on the torch body, and/or the features presently discussed with respect to the torch body may additionally or alternatively be implemented on the consumable.

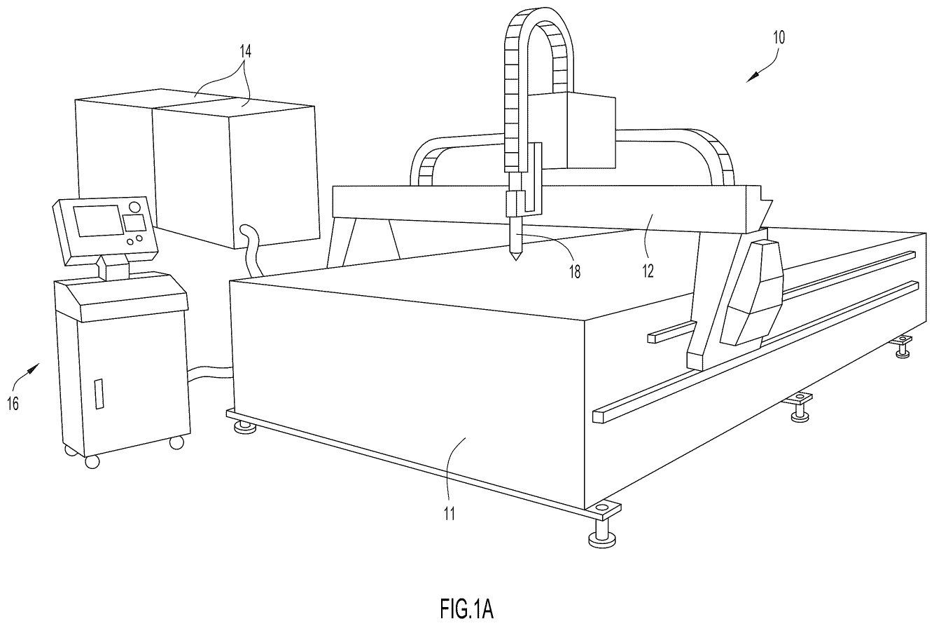

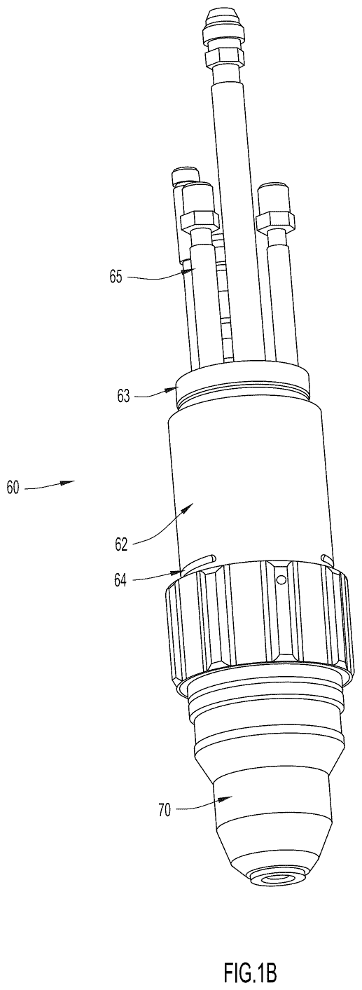

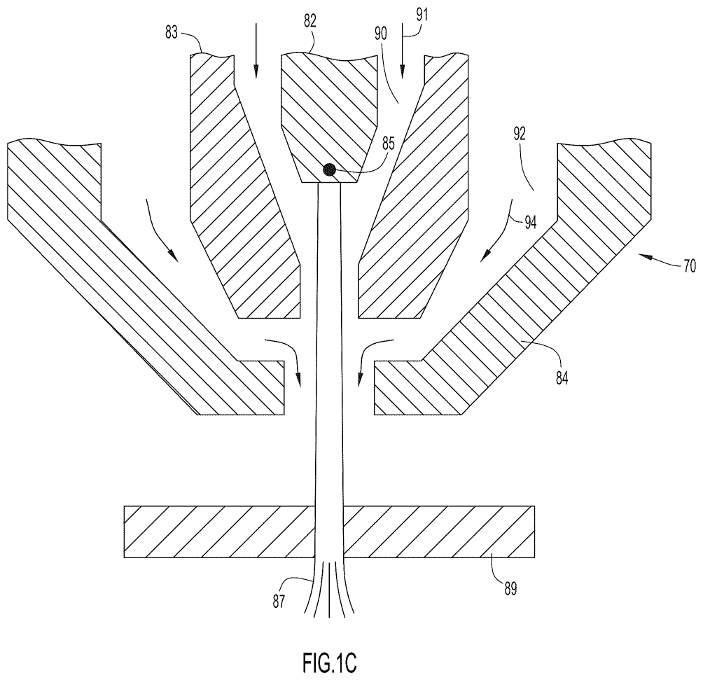

FIG. 1A illustrates an example embodiment of an automated cutting system 10 that may execute the techniques presented herein. However, this automated cutting system 10 is merely presented by way of example and the techniques presented herein may also be executed by manual cutting systems and/or automated cutting systems that differ from the automated cutting system 10 of FIG. 1A (e.g., any robotic or partially robotic cutting system). That is, the cutting system 10 illustrated in FIG. 1A is provided for illustrative purposes.

At a high-level, the cutting system 10 includes a table 11 configured to receive a workpiece (not shown), such as, but not limited to, sheets of metal. The automated cutting system also includes a positioning system 12 that is mounted to the table 11 and configured to translate or move along the table 11. At least one automated plasma arc torch 18 is mounted to the positioning system 12 and, in some embodiments, multiple automated plasma arc torches 18 may be mounted to the positioning system 12. Thus, the plasma arc torches 18 are interchangeable components configured to be selectively implemented in the cutting system 10 (e.g., for performing a particular operation) by coupling to the positioning system 12. The positioning system 12 may be configured to move, translate, and/or rotate the torch 18 in any direction (e.g., to provide movement in all degrees of freedom).

Additionally, at least one power supply 14 is operatively connected to the automated plasma arc torch 18 and configured to supply (or at least control the supply of) electrical power and flows of one or more fluids to the automated plasma arc torch 18 for operation. Finally, a controller or control panel 16 is operatively coupled to and in communication with the automated plasma arc torch 18, the one or more power supplies 14, and the positioning system 12. The controller 16 may be configured to control the operations of the automated plasma arc torch 18, one or more power supplies 14, and/or the positioning system 12, either alone or in combination with the one or more power supplies 14.

In at least some embodiments, the one or more power supplies 14 meter one or more flows of fluid received from one or more fluid supplies before or as the one or more power supplies 14 supply gas to the torch 18 via one or more cable conduits. Additionally or alternatively, the automated cutting system 10 may include a separate fluid supply unit (not shown) or units that can provide one or more fluids to the automated torch 18 independent of the one or more power supplies 14. To be clear, as used herein, the term “fluid” shall be construed to include a gas or a liquid. The one or more power supplies 14 may also condition, meter, and supply power to the automated torch 18 via one or more cables, which may be integrated with, bundled with, or provided separately from cable conduits for fluid flows. Additional cables for data, signals, and the like may also interconnect the controller 16, the automated plasma arc torch 18, the power supply 14, and/or the positioning system 12. Any cable or cable conduit/hose included in the automated cutting system 10 may be of any length. Moreover, each end of any cable or cable conduit/hose may be connected to components of the automated cutting system 10 via any connectors now known or developed hereafter (e.g., via releasable connectors).

FIG. 1B illustrates an example embodiment of an automated cutting head 60 that may be used with an automated cutting system executing the techniques presented herein (e.g., the cutting system 10 of FIG. 1A). As can be seen, the cutting head 60 includes a body 62 that extends from a first end 63 (e.g., a connection end 63) to a second end 64 (e.g., an operating or operative end 64). The connection end 63 of the body 62 may be coupled (in any manner now known or developed hereafter) to an automation support structure (e.g., a cutting table, robot, gantry, etc., such as positioning system 12). Meanwhile, conduits 65 extending from the connection end 63 of the body 62 may be coupled to like conduits in the automation support structure (e.g., positioning system 12) to connect the automated cutting head 60 to a power supply, one or more fluid supplies, a coolant supply, and/or any other components supporting automated cutting operations.

At the other end, the operative end 64 of the body 62 may receive interchangeable components, including consumable components 70 that facilitate cutting operations. For simplicity, FIGS. 1A and 1B do not illustrate connections portions of the body 62 that allow consumable components 70 to connect to the torch body 62 in detail. However, it should be understood that the cutting consumables, such as those schematically illustrated in FIG. 1C, may be coupled to a torch body 62 in any manner. Moreover, to be clear, the consumable stack 70 depicted in FIGS. 1B and 1C (with an external perspective view and a schematic cross-sectional illustration, respectively) is merely representative of a consumable stack that may be used with an automated torch executing the techniques presented herein. Similarly, while none of the Figures of the present application illustrates an interior of torch body 62, it is to be understood that any unillustrated components that are typically included in a torch, such as components that facilitate cutting operations, may (and, in fact, should) be included in a torch executing example embodiments of the present application.

Now turning to FIG. 1C, this Figure is a simplified/schematic illustration of the consumable stack 70 of FIG. 1B. As mentioned, FIG. 1C only illustrates select components or parts that allow for a clear and concise illustration of the techniques presented herein. Thus, in FIG. 1C, only an electrode 82, a nozzle 83, and a shield cap 84 of the consumable stack 70 are depicted. As can be seen, the electrode 82 is disposed at a center of the consumable stack 70 and includes an emitter 85 (e.g., formed from hafnium, tungsten, and/or other emissive materials) at a distal end portion thereof. The torch nozzle 83 is generally positioned around the electrode 82. In some embodiments, the nozzle 83 is installed after the electrode 82. Alternatively, the electrode 82 and nozzle 83 can be installed onto the torch body as a single component (e.g., these components may be coupled to each other to form a cartridge and installed on/in the torch body as a cartridge). In either case, the nozzle 83 may be spaced from the electrode 82; or, at least a distal portion of the nozzle 83 may be spaced apart from the distal portion of the electrode 82.

The shield 84 is positioned radially exteriorly of the nozzle 83 and is spaced apart from the nozzle, at least at its distal end. In some embodiments, the shield 84 is installed around an installation flange of the nozzle 83 in order to secure nozzle 83 and electrode 82 in place at (and in axial alignment with) an operating end of the torch body. Additionally or alternatively, the nozzle 83 and/or electrode 82 can be secured or affixed to a torch body in any desirable manner, such as by mating threaded sections included on the torch body with corresponding threads included on the components. For example, in some implementations, the electrode 82, nozzle 83, shield 84, as well as any other components (e.g., a lock ring, spacer, secondary cap, etc.) may be assembled together in a cartridge that may be selectively coupled to the torch body, e.g., by coupling the various components to a cartridge body or by coupling the various components to each other to form a cartridge.

In use, a plasma torch is configured to emit a plasma arc 87 between the electrode 82 and a workpiece 89 to which a work lead associated with a power supply is attached (not shown). As shown in FIG. 1C, the nozzle 83 is spaced a distance away from the electrode 82 so that a plasma gas flow channel 90 is disposed therebetween. During piercing and cutting operations, a plasma gas 91 flows through the plasma gas flow channel 90. The shield 84 is also spaced a distance away from the nozzle 83 so that a shield flow channel 92 is disposed between the shield 84 and the nozzle 83. A shield fluid 94 flows through the shield flow channel 92 during at least a portion of the time the torch is operated.

Although the present disclosure is primarily directed to a torch used in a cutting operation, it should be noted that techniques discussed herein can be applied to any other suitable system. For example, certain features may be applied to a torch configured to perform a welding operation in which material is melted onto a workpiece.

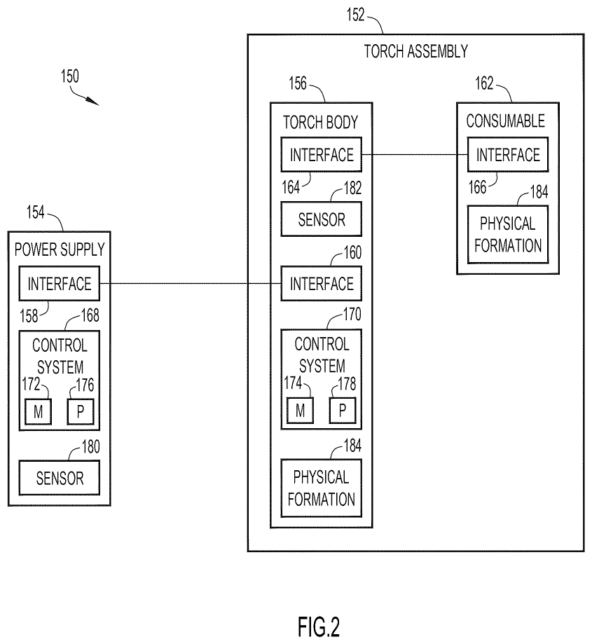

FIG. 2 is a schematic diagram of a torch or torch system 150 (e.g., the cutting system 10). The torch system 150 includes a torch assembly 152 and a power supply 154. The power supply 154 is configured to adjust certain operational parameters or settings for the torch assembly 152. The torch assembly 152 includes a torch body 156 configured to couple to the power supply 154. For example, the power supply 154 may include a power supply interface 158 (e.g., a torch mount), and the torch body 156 may include a first torch body interface 160 (e.g., the conduits 65) configured to couple to and mate with the power supply interface 158. The torch body 156 is also configured to attach to a consumable 162 of the torch assembly 152. To this end, the torch body 156 includes a second torch body interface 164 (e.g., at the operative end 64) configured to couple to and mate with a consumable interface 166 of the consumable 162.

In some embodiments, the consumable 162 may be one of a plurality of consumables 162 that may each be interchangeably coupled to the torch body 156. In other words, the torch body 156 may individually couple to each of the plurality of consumables 162. Additionally or alternatively, the torch body 156 may be one of a plurality of torch bodies 156 that may each be interchangeably coupled to the power supply 154. Therefore, the consumable 162 and the torch body 156 are interchangeable torch components. In at least some instances, different consumables 162 and/or torch bodies 156 may operate more suitably under different operational parameters provided by the power supply 154. For this reason, the power supply 154 may adjust the operational parameters based on the torch body 156 attached to the power supply 154 and/or the consumable 162 attached to the torch body 156.

To this end, the power supply 154 may include a first control system 168 for identifying the torch body 156 coupled to the power supply 154, and the torch body 156 may include a second control system 170 for identifying the consumable 162 coupled to the torch body 156. The first control system 168 and the second control system 170 are also communicatively coupled to one another to operate the torch assembly 152. For instance, the first control system 168 and the second control system 170 may be configured to communicate with one another to adjust operational parameters (e.g., based on an identified torch body embodiment and/or consumable embodiment implemented in the torch assembly 152) and/or to operate torch components (e.g., sensors).

The first control system 168 and the second control system 170 include a first memory 172 and a second memory 174, respectively. Each memory 172, 174 is configured to store data, such as instructions to operate various techniques discussed herein. Each memory 172, 174 may include read only memory (ROM), random access memory (RAM), magnetic disk storage media devices, optical storage media devices, flash memory devices, electrical, optical, or other physical/tangible (e.g., non-transitory) memory storage devices or other computer-readable media encoded with software comprising computer executable instructions. Additionally, the first control system 168 and the second control system 170 include a first processor 176 and a second processor 178, respectively. Each of the processors 176, 178 (e.g., representative of one or more processors, such as processing circuitry) is configured to execute instructions in its associated memory to carry out operations described herein.

By way of example, the engagement between the power supply interface 158 and the first torch body interface 160 may indicate the torch body embodiment (e.g., type, identity). Additionally or alternatively, the engagement between the second torch body interface 164 and the consumable interface 166 may indicate the consumable embodiment (e.g., type, identity). In certain embodiments, the power supply 154 and the torch body 156 include respective sensors 180, 182 configured to determine the respective engagements and to transmit data to the control systems 168, 170 to indicate the engagements.

Based on the received signals, the control systems 168, 170 are configured to establish the operational parameters for operating the torch assembly 152. For instance, different engagements may indicate different consumable embodiments and/or different torch body embodiments implemented in the torch assembly 152, as well as the associated operational parameters suitable for operating each interchangeable torch component embodiment. The control systems 168, 170 may therefore select the particular operational parameters to be provided based on the specifically identified engagements. The operational parameters may include, for example, power/current settings, gas flow settings, such as a type of gas being used, a pressure or flow rate, a gas function (e.g., pre-flow and post-flow, cut gas, shield gas), and/or gas sequencing, positional settings (e.g., movement of a positioning system), such as travel speed, pierce height, standoff/cut height, and/or pierce dwell time, and so forth. Providing the operational parameters suitable for the particular interchangeable torch component embodiments improves operation of the torch system 150, such as a useful lifespan of the torch assembly 152.

In some embodiments, the first torch body interface 160 of the torch body 156 and/or the consumable interface 166 of the consumable 162 include a physical formation 184, such as a contour or physical profile, of a portion (e.g., a surface) of the interchangeable torch component. For instance, the first torch body interface 160 and/or the consumable interface 166 may include bumps, extensions, depressions, textures, protrusions, cutouts, markings, or any other suitable mechanical feature that provides a particular engagement, such as specific contact points, with a corresponding interface (e.g., with the power supply interface 158, with the second torch body interface 164). Indeed, different torch bodies 156 and/or consumables 162 may be manufactured to have different physical formations 184, such as different types of mechanical features, different arrangements of features (e.g., bumps positioned at different locations), and/or different magnitude of features (e.g., bumps that extend at different heights), to provide different engagements. Therefore, each different engagement is specifically associated with a corresponding embodiment of the interchangeable torch component.

It should be noted that although the present disclosure primarily discloses establishing operating parameters based on engagement between a power supply 154 and a torch body 156 and/or a torch body 156 and a consumable 162, operating parameters may be established based on engagement between other components of the torch system. Various physical formations 184 that provide engagements between the components of the torch system are further discussed herein.

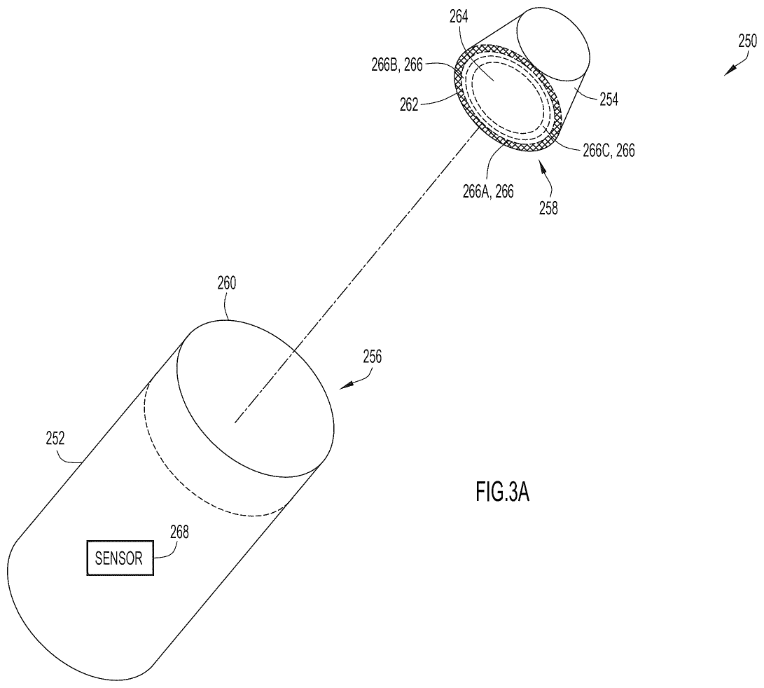

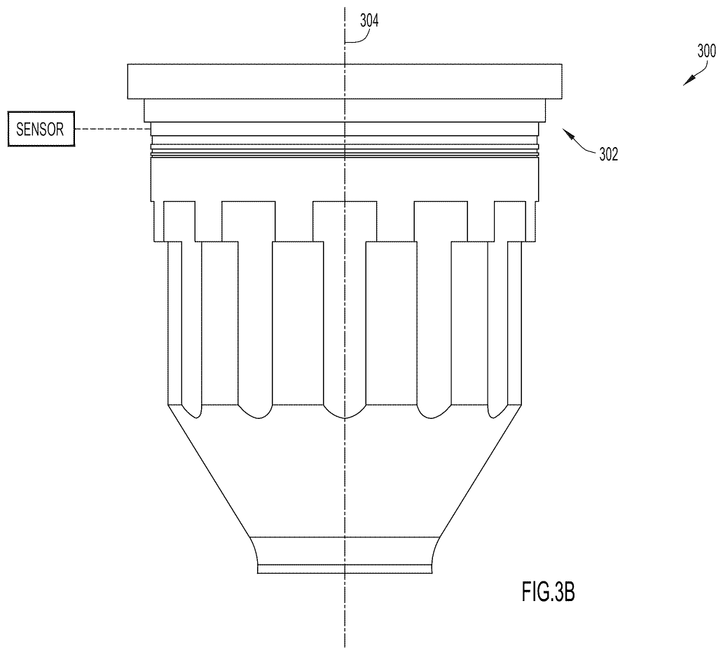

FIG. 3A is a perspective side view of a torch assembly 250 with a torch body 252 and a consumable 254 configured to couple to one another. The torch body 252 includes a first interface 256 configured to engage with a second interface 258 of the consumable 254 in an assembled configuration of the torch assembly 250. The first interface 256 includes a first surface 260, and the second interface 258 includes a second surface 262 that surrounds an opening 264 exposing an interior of the consumable 254. The second surface 262 is configured to engage with the first surface 260 in the assembled configuration. The second surface 262 includes physical formations in the form of several circumferential bands 266 (e.g., grooves, hollow circles, annular rings) that are radially offset from one another and that provide a particular engagement between the first interface 256 and the second interface 258.

For example, each circumferential band 266 may engage with a particular portion of the first surface 260. That is, during engagement between the first interface 256 and the second interface 258, each circumferential band 266 may be at a particular position with respect to the first interface 256. The positioning of each circumferential band 266 may indicate the embodiment of the consumable 254 coupled to the torch body 252. For this reason, the torch body 252 includes a sensor 268 configured to determine the position of each circumferential band 266 while the first interface 256 and the second interface 258 are engaged with one another in the assembled configuration. In certain embodiments, the sensor 268 includes a contact or position sensor configured to mechanically determine the position of the circumferential bands 266 (e.g., based on contact between the circumferential bands 266 with the first interface 256). In additional or alternative embodiments, the sensor 268 includes a visual sensor configured to capture an image of the circumferential bands 266 to determine the positioning of the circumferential bands 266, such as based on the pixel location/quantity of each circumferential band 266. Other sensors may also be utilized.

Indeed, different consumables 254 may have different arrangements of circumferential bands 266, such as circumferential bands 266 having different diameters/widths, circumferential bands 266 having different concentricity, circumferential bands 266 having different surface textures, and/or different quantities of circumferential bands 266. The sensor 268 is configured to determine the particular arrangement of circumferential bands 266 for identifying the corresponding consumable 254. The operating parameters may then be established based on the particular arrangement of circumferential bands 266 (e.g., based on data transmitted by the sensor). As an example, the positioning of the circumferential bands 266 may be compared with expected positionings of circumferential bands 266 associated with different consumable embodiments. In response to determining the circumferential bands 266 align with corresponding expected positionings to indicate a particular consumable embodiment is coupled to the torch body 252, the operational parameters associated with the particular consumable embodiment are selected and implemented. As another example, the surface texture of each circumferential band may be determined. For instance, in response to a first circumferential band 266A (e.g., an outer circumferential band) having a rough surface and a second circumferential band 266B (e.g., an inner circumferential band) having a smooth surface to indicate a particular consumable 254 is coupled to the torch body 252, the operational parameters associated with the particular consumable 254 are selected and provided.

In some embodiments, each circumferential band 266 indicates a different parameter. For example, a characteristic of the first circumferential band 266A may indicate a power/current level, a characteristic of the second circumferential band 266B may indicate a manufacturer, and a characteristic of a third circumferential band 266C (e.g., an intermediate circumferential band) may indicate an operation type. Thus, different parameters are determined via the characteristics of each respective circumferential band 266, such as for establishing the operational parameters accordingly.

Furthermore, in some circumstances, the identified arrangement of the circumferential bands 266 may not match any expected arrangement. In other words, a particular consumable embodiment may not be identifiable based on the arrangement of circumferential bands 266. For example, an incompatible or unsuitable consumable 254 may be coupled to the torch body 252. In response, operation of the torch or torch system may not be initiated to avoid performing an operation that otherwise may negatively affect a structural integrity of the torch assembly 250 and/or may not provide desirable cutting results. Alternatively, the torch may operate at low operational settings, e.g., to limit wear imparted to the consumable 254 and/or in an attempt to avoid using increased power for an incompatible consumable 254.

The circumferential bands 266 of FIG. 3A are provided along a planar surface. However, circumferential bands may be provided in a different manner. FIG. 3B is a side view of a consumable 300 having circumferential bands 302 that each extend along a circumferential surface. That is, the circumferential bands 302 include a surface facing away from the interior of the consumable 300 for engagement with a torch body, and the circumferential bands 302 are offset from one another along an axis 304 of extension of the consumable 300. The circumferential bands 302 may have different characteristics detectable by a sensor of the torch body to help distinguish the consumable 300. For example, the consumable 300 may include circumferential bands 302 having different diameters/widths, circumferential bands 302 having different concentricity, circumferential bands 302 having different textures, and/or different quantities of circumferential bands 302.

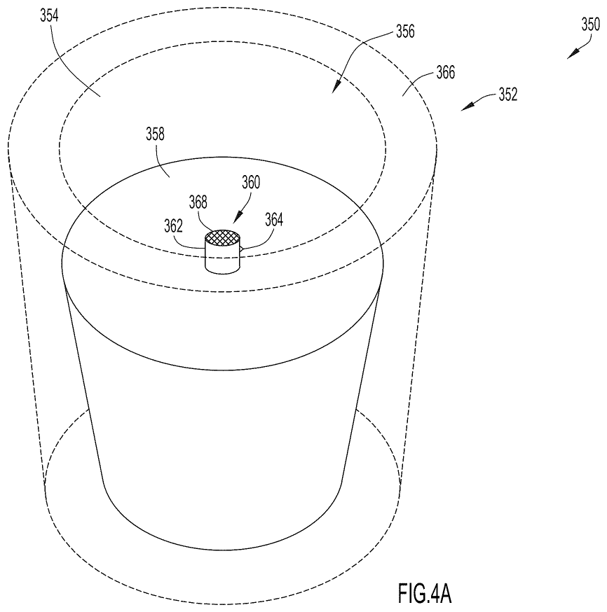

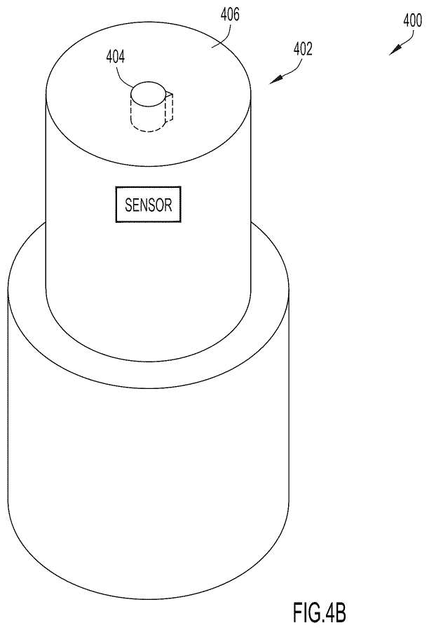

FIG. 4A is a top perspective view of a consumable 350 with an interface 352 configured to engage with a torch body in an assembled configuration. The interface 352 includes a sidewall 354 circumferentially surrounding and defining an opening 356, a surface 358 positioned within the opening 356, and a physical formation in the form of an extension 360 extending from the surface 358. The opening 356 is configured to receive a portion of the torch body to engage the extension 360 with the torch body. For simplicity, a large majority of the techniques presented herein are described with respect to this overall geometry of the consumable 350, but to be clear, this overall geometry is merely one example consumable geometry that may implement the techniques presented herein. For example, in other embodiments, the opening 356 shown in FIG. 4A need not be a central opening and may, for example, be defined within another annular body of a consumable (so the opening 356 is not aligned with a central axis of the consumable 350). Still further, in some instances, the torch body may define an opening and the consumable 350 may define a protrusion that can insert into the torch body opening. That is, in other embodiments, the torch body may include a female portion of a coupling and the consumable 350 may include a male portion of the coupling.

Regardless of its location, the extension 360 may be particularly shaped to be able to insert into an aperture of the torch body. Indeed, the aperture of the torch body may be shaped to enable insertion of the extension therein and to block insertion of extensions having other shapes. In the illustrated embodiment, the extension 360 includes a cylindrical base 362 and a triangular bump 364 extending radially outward from the cylindrical base 362. However, the extension 360 can have any suitable shape (e.g., cross-sectional shape), such as differently arranged dimples, cuts, bitting, etc. and extend in any direction (e.g., radially, axially, at a skew angle). Indeed, the extension 360 can be shaped to provide an additional function for identification (e.g., by visual observation), such as providing Braille for tactile feedback of words, providing a trademark to indicate a manufacturer, and the like. Moreover, the extension 360 need not be positioned within an opening defined by a sidewall of a consumable. For example, the extension 360 can extend from a distal surface 366 of the sidewall 354 of the consumable 350.

A portion of the extension 360 can include an additional characteristic for distinguishing the consumable 350 and establishing certain operating parameters accordingly. For instance, a surface 368 of the extension 360 may include a texture that further indicates a certain operating parameter to be provided. As another example, the extension 360 may have specific notches, ridges, etc. (e.g., resembling a key). Thus, even though different consumables 350 can include similarly shaped extensions (e.g., extensions that each include a cylindrical base 362 and a triangular bump 364) to enable desirable engagement with the torch body, each extension 360 may include different characteristics to help distinguish the different consumables 350 from one another. Additionally or alternatively, the cylindrical base 362 may include such features. In any case, more suitable operating parameters may be established for the consumable 350 based on these features.

In certain embodiments, the extension 360 is provided via a machining process in which material is removed from the consumable to form the extension 360. In additional or alternative embodiments, the extension 360 is provided via a casting technique. In further embodiments, the extension 360 is provided via an additive manufacturing process, such as three-dimensional printing or other attachment of a separate extension to the surface 358.

FIG. 4B is a perspective view of a torch body 400 that is arranged in an upward-facing orientation. The torch body 400 includes a distal portion 402 configured to insert into the opening 356 of the consumable 350 in the assembled configuration. The torch body 400 also includes a receptacle or socket 404 formed into a surface 406 of the distal portion 402, and the receptacle 404 is shaped to receive the correspondingly shaped extension 360 of the consumable 350. Therefore, the torch body 400 is configured to fully insert into the opening 356 of the consumable 350. Such engagement between the torch body 400 and the consumable 350 may indicate parts-in-place for a compatible, mated consumable 350. In turn, this may enable initiation of operation of the torch. In contrast, a consumable 350 that includes an extension 360 that is not correspondingly shaped with respect to the receptacle 404 may not be able to extend into the receptacle 404, thereby blocking full insertion of the torch body 400 into the consumable 350 or vice versa (e.g., the surface 406 of the torch body 400 may not engage with the surface 358 of the consumable 350). For example, a consumable 350 that does not include the correspondingly shaped extension 360 may be incompatible with the torch body 400. Initiation of the torch may be blocked when the torch body 400 and the consumable 350 are not fully engaged with one another (e.g., as a result of an incompatible consumable 350 having a differently shaped extension 360 or because the extension 360 of a compatible consumable 350 has moved out of the receptacle 404 to indicate the consumable 350 is to be repositioned).

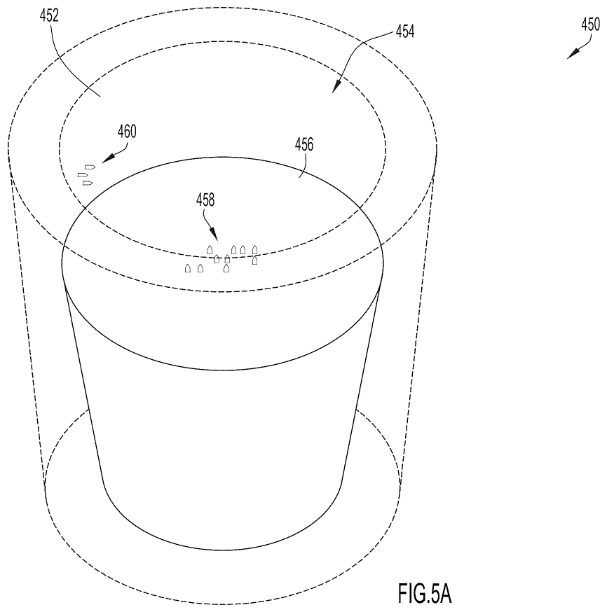

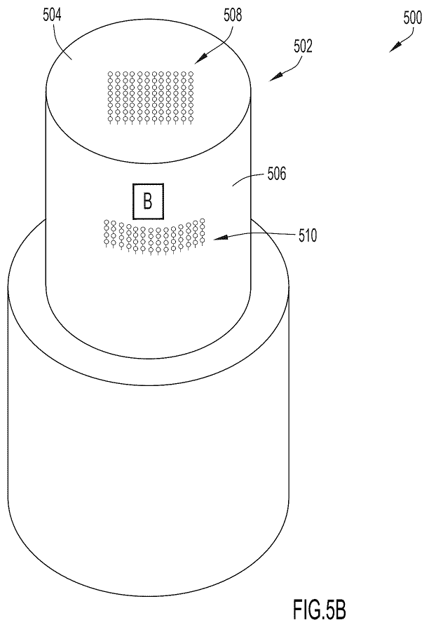

FIG. 5A is a top perspective view of a consumable 450 with a sidewall 452 circumferentially surrounding and defining an opening 454, as well as a surface 456 positioned within the opening 454. The consumable 450 also includes physical formations in the form of first extensions 458 (e.g., first embossment) extending from the surface 456 into the opening 454 and second extensions 460 (e.g., second embossment) extending from the sidewall 452 into the opening 454. Each of the extensions 458, 460 may be machined to provide a respective discrete, local point of contact with a portion of a torch body to provide a particular engagement with the torch body. In one example, the extensions 458, 460 may provide a Braille marking, trademark, and/or other feature that can also be observed by a user to ascertain a meaning provided by the extensions.

FIG. 5B is a perspective view of a torch body 500, again arranged in an upward-facing orientation, with a distal portion 502 configured to insert into the opening 454 of the consumable 450 in the assembled configuration. The distal portion 502 includes a distal surface 504 and side surface 506. First pins 508 extend from the distal surface 504, and second pins 510 extend from the side surface 506. Each of the pins 508, 510 are configured to move relative to their corresponding support surfaces 504, 506, such as by translating into and out of the corresponding surfaces 504, 506 (along an axis, such as an axis of extension of the torch body and/or a radius of the torch body). For instance, one or more biasing members may be configured to impart a force onto each pin 508, 510 to urge the pins 508, 510 to extend out of the corresponding surfaces 504, 506. However, a sufficient force counteracting the force imparted by the one or more biasing members moves the pins 508, 510 inward toward the corresponding surfaces 504, 506.

By way of example, engaging the torch body 500 with the consumable 450 may cause the extensions 458, 460 to engage with the pins 508, 510 to move the pins 508, 510. For instance, fully inserting the distal portion 502 of the torch body 500 into the opening 454 of the consumable 450 in the assembled configuration may cause the first extensions 458 extending from the surface 456 of the consumable 450 to maintain engagement with the first pins 508 extending from the distal surface 504 of the torch body 500. As a result, a subset of the first pins 508 is moved (e.g., translated into the distal surface 504). Because the first extensions 458 are positioned at particular locations relative to one another, each first extension 458 will align with and therefore move a certain first pin 508. That is, the first extensions 458 of the consumable 450 are arranged to move certain first pins 508, and not other first pins 508, of the torch body 500. As such, the particular first pins 508 that have been moved indicate the arrangement of the first extensions 458 of the consumable 450. Indeed, each different consumable 450 may include first extensions 458 arranged in different positions and configured to move different ones of the first pins 508. Therefore, the positioning of the first pins 508 (e.g., the first pins 508 that have been moved) while the consumable 450 and the torch body 500 are engaged with one another may indicate that a specific consumable embodiment is coupled to the torch body 500.

In certain embodiments, the first extensions 458 may extend at different distances away from the surface 456 of the consumable 450. Consequently, the first extensions 458 may cause the first pins 508 to move (e.g., translate into the distal surface 504) by different amounts in the assembled configuration. The translation amount of the first pins 508 may therefore also be used to identify the consumable 450 coupled to the torch body 500.

It should also be noted that movement of the second pins 510 may also be used to identify the consumable 450 using a similar technique. In particular, inserting the distal portion 502 of the torch body 500 into the opening 454 of the consumable 450 may move the side surface 506 of the distal portion 502 along the sidewall 452 of the consumable 450 and cause the second extensions 460 extending from the sidewall 452 to contact the second pins 510 extending from the side surface 506. As a result, a subset of the second pins 510 corresponding to the positioning of the second extensions 460 is moved (e.g., translated into the side surface 506), and the positioning of second pins 510 indicates the arrangement of the second pins 510 of a particular consumable embodiment. In some embodiments, fully inserting the torch body 500 into the consumable 450 causes the second extensions 460 to maintain engagement with the second pins 510. Thus, the positioning of the second pins 510 while the torch body 500 and the consumable 450 are engaged with one another in the assembled configuration may be used to identify a particular consumable embodiment coupled to the torch body 500.

In additional or alternative embodiments, inserting the torch body 500 into the consumable 450 causes the second extensions 460 to pass over different ones of the second pins 510. That is, as the torch body 500 is inserted into the consumable 450, each second extension 460 contacts a different second pin 510 at different times while the second extension 460 passes over different second pins 510 (e.g., a second extension 460 does not necessarily rest in engagement with a single second pin 510 while the consumable 450 is being fully installed). Consequently, different second pins 510 are moved by the second extensions 460 over a duration of time during which the torch body 500 is inserted into the consumable 450. For this reason, the position of each second pin 510 at different durations of time (e.g., a sequence of second pins 510 being moved) may indicate the arrangement of the second pins 510 of a particular consumable embodiment.

In either of these embodiments, the positioning of the pins 508, 510 (e.g., maintained positioning, positioning over time) indicates the consumable embodiment coupled to the torch body 500. For example, a processor (e.g., the first processor 176) may generate a signal based on the positioning of the pins 508, 510 of the torch body 500, which corresponds to an arrangement (e.g., a location, a distance) of the extensions 458, 460 of the consumable 450. The signal varies based on the positioning of the pins 508, 510 (e.g., movement of the pins 508, 510 changes the signal being transmitted), such as by using a variable resistor to generate a signal. For instance, the variable resistor may include a resistance used to generate the signal (e.g., a signal having a particular voltage and/or current), and changing the positioning of the pins 508, 510 may change the resistance. Therefore, changing the positioning of the pins 508, 510 also changes the signal generated based on the resistance of the variable resistor. The signal affects operation of the torch. For instance, the positioning of the pins 508, 510 matching certain expected positions may cause a signal to transmit and initiate the operation of the torch, such as by providing operating parameters based on the signal.

However, if the processor determines that pins 508, 510 are at unexpected positions, which may indicate an incompatible consumable 450 is attached to the torch body 500, the processor may transmit a signal that blocks operation of the torch. In embodiments in which extensions 458, 460 (e.g., the second extensions 460) pass over different pins 508, 510 (e.g., the second pins 510) while the torch body 500 is being inserted into the consumable 450 toward the assembled configuration, different signals may be transmitted at certain times and/or in a particular sequence as the different pins 508, 510 are moved by contacting the extensions 458, 460 to change the positioning of the pins 508, 510. Thus, the particular signals being transmitted while the torch body 500 is being inserted into the consumable 450 may be used to determine whether a desirable consumable 450 is being coupled to the torch body 500 for initiating operation of the torch (e.g., based on the particular signals being transmitted at target times and/or in a target sequence).

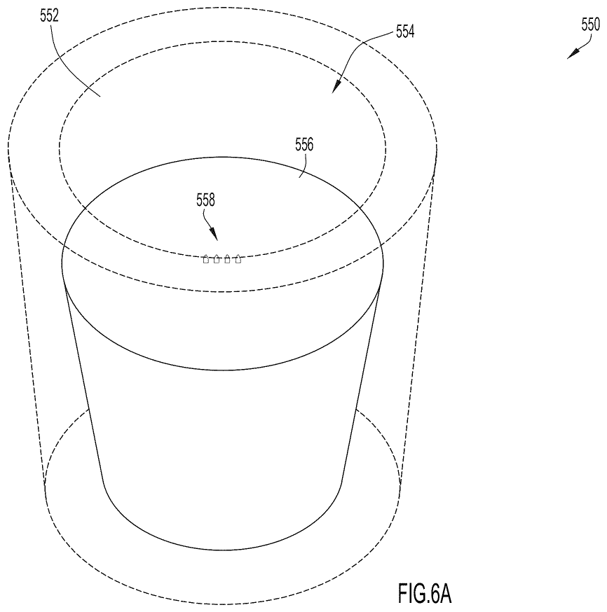

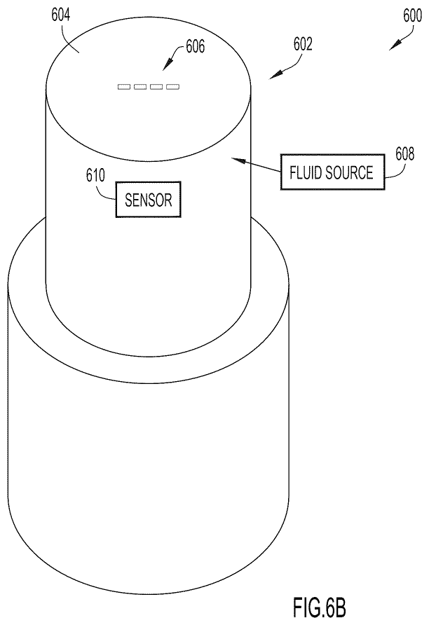

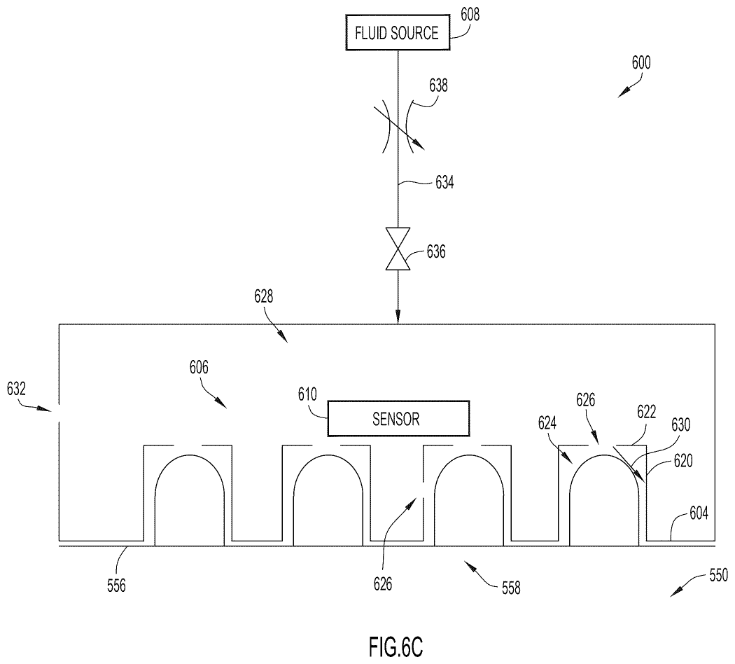

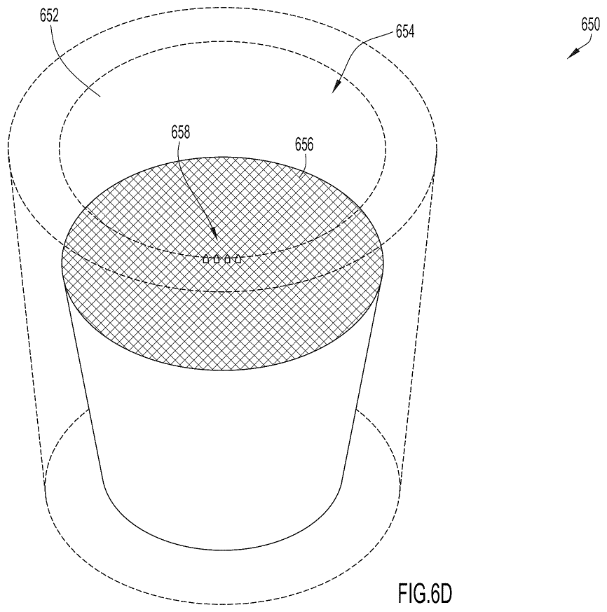

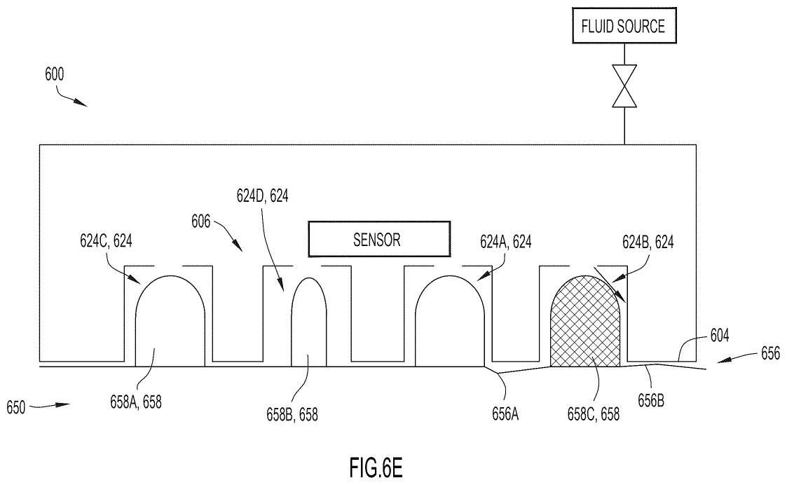

FIG. 6A is a top perspective view of a consumable 550 with a sidewall 552 circumferentially surrounding and defining an opening 554, a surface 556 positioned within the opening 554, and physical formations in the form of extensions 558 (e.g., embossment) extending from the surface 556 into the opening 554. To reiterate, this geometry of the consumable 550 is merely an example geometry and, regardless of the consumable geometry, each of the extensions 558 may be machined and particularly positioned to provide a particular engagement with a torch body. For example, the extensions 558 may provide a Braille marking, trademark, or other feature that can also be visually observed by a user to ascertain a meaning provided by the extensions 558.

FIG. 6B is a perspective view of a torch body 600, again in an upwardly-facing orientation, with a distal portion 602 configured to insert into the opening 554 of the consumable 550 in an assembled configuration (which, again, is merely an example). The distal portion 602 includes a distal surface 604 and apertures 606 formed into the distal surface 604 (e.g., via drilling, milling, and/or any other suitable machining technique). The apertures 606 are configured to receive extensions 558 of the consumable 550 to form chambers in the assembled configuration.

A consumable 550 with desirably formed extensions 558 provides at least a partial seal of the apertures 606. In other words, the desirably formed extensions 558 sealingly engage with the torch body 600. To determine whether a sealed engagement is formed between the torch body 600 and the extensions 558, a fluid source 608 is configured to direct fluid to fill the chambers, increasing the pressure (e.g., a fluid pressure) within the chambers to a threshold pressure when there is at least a partial seal. For example, a flow control valve (e.g., a regulator) may be used to provide constant and stable flow of fluid (e.g., at a constant flow rate) through the conduit until the threshold pressure is reached. In certain embodiments, the fluid is the same plasma gas used to generate an arc. Thus, a first portion of the plasma gas is directed into the chambers to fill the chambers, and a second portion of the plasma gas (e.g., the plasma gas 91) is directed by the torch body 600 to the consumable 550 to generate the arc. That is, the plasma gas is apportioned to fill the chambers and to generate the arc. In additional or alternative embodiments, the fluid source 608 directs a separate, dedicated fluid for evaluating the sealed engagement into the chambers. That is, the fluid that fills the chambers may be different from (e.g., has a different composition than) the plasma gas used to generate the arc. Regardless, upon increasing the pressure within the chambers to a threshold pressure, operation of the fluid source 608 to direct fluid into the apertures is suspended. The fluid is then able to flow between the torch body 600 and the consumable 550 out of the chambers, thereby reducing the pressure within the chambers below the threshold pressure.

However, a sufficient sealed engagement between the extensions 558 and the torch body 600 limits the pressure decay or reduction. Thus, the rate of pressure decay within the chambers and/or leakage of fluid out of the chambers may be monitored to determine whether the consumable 550 includes desirably formed extensions 558 to enable operation of the torch. For example, the rate of pressure decay within the chambers (e.g., caused by leakage of fluid out of the chambers) exceeding a threshold rate may indicate that the consumable 550 does not include extensions that adequately seal the chambers and, therefore, the consumable 550 is not compatible with the torch body 600. To this end, a sensor 610 (e.g., a pressure sensor) is configured to monitor the pressure within the chambers and/or another parameter indicative of flow of fluid out of the chambers.

FIG. 6C is a schematic diagram of a portion of the torch body 600 coupled to a portion of the consumable 550 such that the extensions 558 of the consumable 550 are positioned within the apertures 606 of the torch body 600 in an assembled configuration. Specifically, the torch body 600 includes side surfaces 620 extending from the distal surface 604, as well as back surfaces 622 extending from the side surface 620. While the torch body 600 is engaged with the consumable 550 in the assembled configuration, the surface 556 of the consumable 550 engages with the distal surface 604 of the torch body 600 such that the surface 556 of the consumable 550 and the distal surface 604, the side surfaces 620, and the back surfaces 622 of the torch body cooperatively form respective chambers 624. Additionally, openings 626 are formed through each back surface 622 and/or through the side surfaces 620 such that the chambers 624 are fluidly coupled to an interior 628 of the torch body 600. The fluid source 608 is configured to direct fluid into the interior 628 of the torch body 600 and then into the chambers 624 in a flow direction 630.

In the assembled configuration, the extensions 558 of the consumable 550 extend into the chambers 624. By way of example, the extensions 558 may contact the back surfaces 622 and/or the side surfaces 620 of the torch body 600 and/or the surface 556 from which the extensions 558 extend may contact the distal surface 604 of the torch body 600 to provide a partially or fully sealed engagement between the torch body 600 and the consumable 550. The sealed engagement between the extensions 558 of the consumable 550 and the apertures 606 reduces fluid flow out of the chamber 624. Therefore, a pressure within chambers caused by fluid flow buildup in the chambers 624 is maintained. In other words, a pressure decay (i.e., a rate in which pressure decreases) within the chambers 624 is reduced. Indeed, the pressure decay in the illustrated configuration may be relatively lower than a pressure decay of a configuration in which an incompatible or other undesirable consumable arrangement (e.g., that does not include extensions 558 or other physical formations that provide a sealed engagement with the apertures 606) is coupled to the torch body 600. In embodiments with a full seal, pressure may dissipate through a vent 632 (e.g., atmospheric vent) that is upstream of the mating point between the consumable 550 and torch body 600, such as within the torch body 600 to enable fluid to flow out of the chambers 624, into the interior 628 of the torch body 600, and through the vent 632.

During operation of the torch, the fluid source 608 initially directs fluid into the chambers 624 to increase pressure within the chambers 624. For example, the fluid source 608 may direct fluid through a conduit 634 that is fluidly coupled to the interior 628 of the torch body 600. A valve 636, such as an on-off valve or a proportional valve, disposed along the conduit 634 controls fluid flow through the conduit 634. As an example, an on-off valve may be in an open configuration and/or a proportional valve may be controlled to be in an open position (e.g., a fully opened position) to enable fluid flow through the conduit 634 and into the interior 628. Upon the pressure within the chambers 624 reaching a threshold pressure (e.g., as determined by the sensor 610), such as 5.5 bar (80 pounds per square inch), fluid flow directed into the chambers 624 is suspended, such as via the valve 636. A regulator 638 may be disposed along the conduit 634 to maintain fluid flow directed through the conduit 634 (e.g., at a sustained flow rate) into the interior 628. For instance, the on-off valve may be transitioned to a closed configuration and/or the proportional valve may be controlled to be in a closed position (e.g., a fully closed position) to block fluid flow through the conduit 634 and toward the chambers 624, as well as to block fluid flow from the interior 628 of the torch body 600 toward the conduit 634. Consequently, fluid is forced to flow out of the chambers 624 via the apertures 606 (e.g., through the openings 626 of the back surfaces 622, between the extensions 558 of the consumable 550 and the side surfaces 620 of the torch body 600, and/or between the surface 556 of the consumable 550 and the distal surface 604 of the torch body 600) to reduce the pressure within the chambers 624. Such pressure decay is monitored, such as via the sensor 610, and compared to a threshold rate to determine whether the extensions 558 desirably engage with the torch body 600 to provide the sealed engagement, thereby indicating whether the consumable 550 is of a desirable embodiment.

For example, based on the pressure decay being below the threshold rate, thereby indicating that the consumable 550 desirably engages with the torch body 600, operation of the torch may be initiated. However, based on the pressure decay exceeding the threshold rate, thereby indicating the consumable 550 does not desirably engage with the torch body 600, operation of the torch may be blocked from initiating or initiated with limited parameters. In certain embodiments, operating parameters may be established based on the determined pressure decay. For instance, different consumable embodiments (e.g., each having a different set of operating parameters for operation) may provide different rates of pressure decay upon coupling to the torch body. As such, the specific rate of pressure decay may indicate the particular consumable embodiment coupled to the torch body 600 and the corresponding operating parameters to be established to operate the particular consumable embodiment. Thus, operation of the torch may be more granularly controlled based on the rate of pressure decay.

In some embodiments, operations to determine the engagement between the torch body 600 and the consumable 550 may be performed concurrently with operation of the torch assembly to generate an arc. As an example, the fluid source may direct plasma gas that is then apportioned for filling the chambers 624 and for generating the arc. In such embodiments, the fluid line (e.g., the conduit 634) used for directing plasma gas into the chambers 624 is separate from the fluid line used for directing plasma gas to the consumable 550 for generating the arc. Thus, plasma gas can be diverted into the chambers 624 without affecting operation of the torch assembly to generate the arc via the plasma gas. As another example, the fluid source 608 may direct fluid that is separate and different from the plasma gas used for generating the arc. Therefore, the fluid source may operate without affecting operation of the torch assembly to generate the arc via plasma gas.

In additional or alternative embodiments, operations determining engagement between the torch body 600 and the consumable 550 may be performed separately from operation of the torch assembly to generate an arc. For instance, the fluid line used for directing plasma gas into the chambers 624 may be the same as the fluid line used for directing plasma gas to the consumable 550 for generating the arc. As such, the fluid line is utilized for either directing plasma gas to the chambers or directing plasma gas to the consumable 550. By way of example, pressure decay may be monitored after a consumable 550 has been newly attached to the torch body 600 and prior to operation of the torch assembly to generate the arc using the newly attached consumable 550. Upon determining the newly attached consumable 550 is desirably engaged with the torch body 600, pressure decay monitoring is suspended, and operation of the torch assembly to generate the arc is initiated.

In the illustrated embodiment, a single conduit 634 directs fluid flow into the interior 628 of the torch body 600, and fluid within the interior 628 of the torch body is apportioned between the chambers 624. In additional or alternative embodiments, individual conduits direct fluid flow into each chamber 624. That is, a respective, dedicated conduit is used to direct fluid from the fluid source 608 to one of the chambers 624 and not another of the chambers 624. In such embodiments, a respective valve may be used for each conduit to enable and block fluid flow through the conduits (e.g., to independently and separately control fluid movement within the chambers).

To provide different rates of pressure decays, in some embodiments, the surface of the consumable can have a particular profile (e.g., a particular texture) to adjust engagement with the torch body. FIG. 6D is a perspective top view of an embodiment of a consumable 650 with a sidewall 652 circumferentially surrounding and defining an opening 654, a surface 656 positioned within the opening 654, and physical formations in the form of extensions 658 (e.g., embossment) extending from the surface 656 into the opening 654. The surface 656 is textured to adjust engagement with a torch body in an assembled configuration. For example, the texture of the surface 656 may provide a profile that changes a surface area that is in contact with the distal surface of the torch body. Consequently, fluid flow out of the chambers of the torch body is adjusted, thereby changing the rate of pressure decay of the chambers.

FIG. 6E is a schematic diagram of a portion of the torch body 600 coupled to a portion of the consumable 650 such that the extensions 658 of the consumable 650 are positioned within the apertures 606 of the torch body 600 in an assembled configuration. Different portions of the surface 656 of the consumable 650 have different amounts of engagement with the distal surface 604 of the torch body 600. For instance, a first portion 656A of the surface 656 may have a relatively reduced amount of engagement with the distal surface 604, whereas a second portion 656B of the surface 656 may have a relatively increased amount of engagement with the distal surface 604. Consequently, sealing of a first chamber 624A is reduced (e.g., fluid flow between the first portion 656A of the surface 656 and the distal surface 604 is increased at the first chamber 624A), thereby increasing a rate of pressure decay within the first chamber 624A, and sealing of a second chamber 624B is increased (e.g., fluid flow between the second portion 656B of the surface 656 and the distal surface 604 is reduced), thereby reducing a rate of pressure decay within the second chamber 624B. Therefore, different rates of pressure decay within each chamber 624 are effectuated by the surface 656 of the consumable 650, and different consumable embodiments can have different surface profiles/textures that provide varying rates of pressure decay within each chamber 624 to indicate a particular consumable embodiment coupled to the torch body 600 more distinctly. As such, the operating parameters suitable for the coupled consumable embodiments may be established based on the determined rates of pressure decay within each chamber 624.

The consumable embodiments may additionally or alternatively be identified using other factors for establishing the operating parameters suitable for the particular consumable embodiment coupled to the torch body 600. As an example, different consumables 650 may include extensions of different sizes. For instance, a first extension 658A may be relatively larger to increase engagement with the torch body 600 and correspondingly increase sealing of a third chamber 624C, thereby reducing a rate of pressure decay within the third chamber 624C, and a second extension 658B may be relatively smaller to reduce engagement with the torch body 600 and correspondingly reduce sealing of a fourth chamber 624D, thereby increasing a rate of pressure decay within the fourth chamber 624D. Thus, the varying sizes of the extensions 658 also changes the rate of pressure decay within the different chambers 624, and different consumable embodiments can have differently sized extensions 658 to provide varying rates of pressure decay in the chambers 624 to indicate the particular consumable embodiment coupled to the torch body 600. As another example, any of the extensions 658 can have a characteristic that indicates the particular consumable embodiment coupled to the torch body 600. For instance, a third extension 658C may have a textured surface, whereas remaining extensions 658 may have smooth surfaces. As such, different consumable embodiments can have extensions 658 of different textures to indicate the particular consumable embodiment coupled to the torch body.

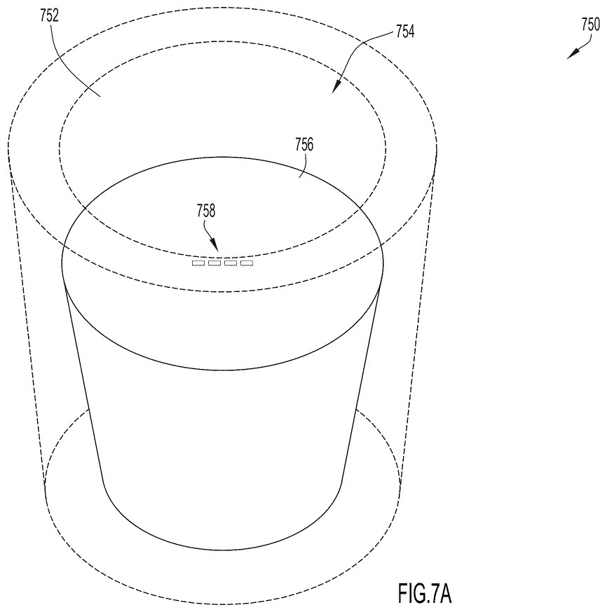

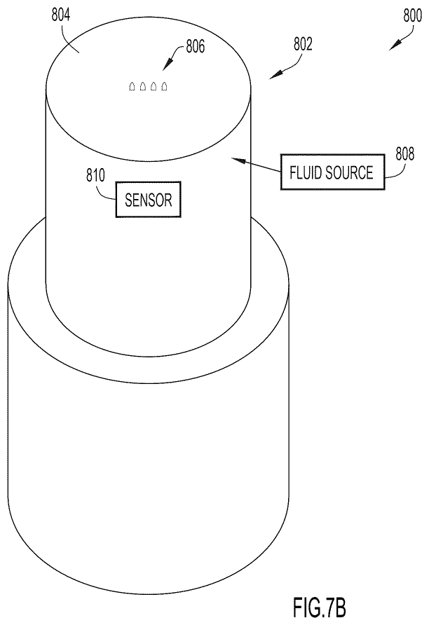

FIG. 7A is a top perspective view of a consumable 750 with a sidewall 752 circumferentially surrounding and defining an opening 754, a surface 756 positioned within the opening, and apertures 758 formed into the surface 756 (e.g., via drilling, milling, and/or any other suitable machining technique). For example, such apertures 758 may have a similar arrangement as the apertures 606 of the torch body 600 described in FIG. 6B.

FIG. 7B is a perspective view of a torch body 800, again in an upwardly-facing orientation, with a distal portion 802 configured to insert into the opening 754 of the consumable 750 in an assembled configuration. The distal portion 802 includes a distal surface 804 and physical formations in the form of extensions 806 (e.g., embossment) extending from the distal surface 804. For instance, the extensions 806 may provide a Braille marking, trademark, or other feature that can also be visually observed by a user to ascertain a meaning provided by the extensions 806. The extensions 806 are configured to extend into the apertures 758 of the consumable 750 to form chambers in the assembled configuration.

Engagement between the extensions 806 and the apertures 758 may be used to determine whether the consumable 750 is desirable (e.g., includes desirably sized apertures 758). To this end, a fluid source 808 is configured to direct fluid to fill the chambers to increase pressure within the chambers to a threshold pressure, and a pressure decay or reduction caused by fluid flow out of the chambers is monitored (e.g., via a sensor 810) to determine whether the consumable 750 is desirable to enable operation of the torch. A desirable consumable 750 provides apertures 758 that are at least partially sealed such that the rate of pressure decay within the chambers exceeding a threshold rate may indicate that the consumable 750 does not include apertures 758 that adequately engage with the extensions 806 of the torch body 800 to provide the partial seal and, therefore, the consumable 750 is not compatible with the torch body 800.

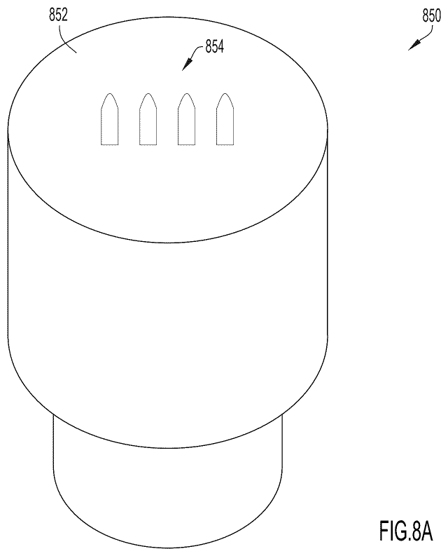

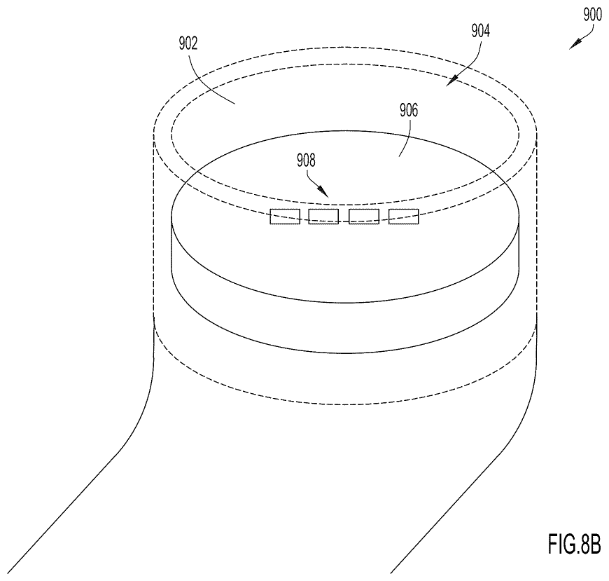

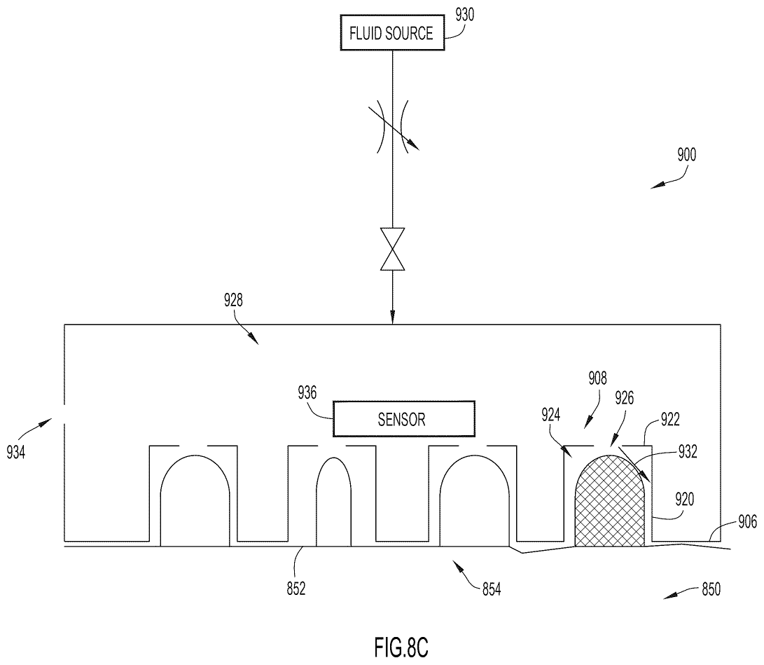

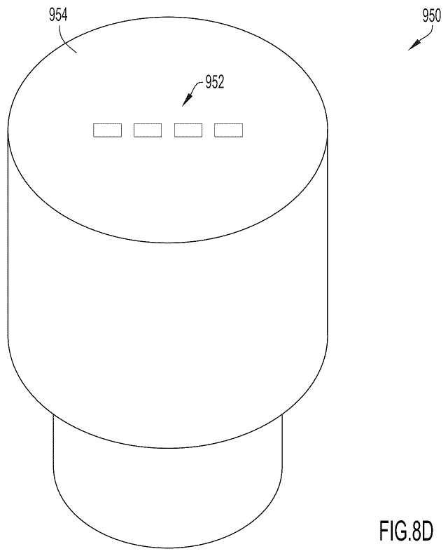

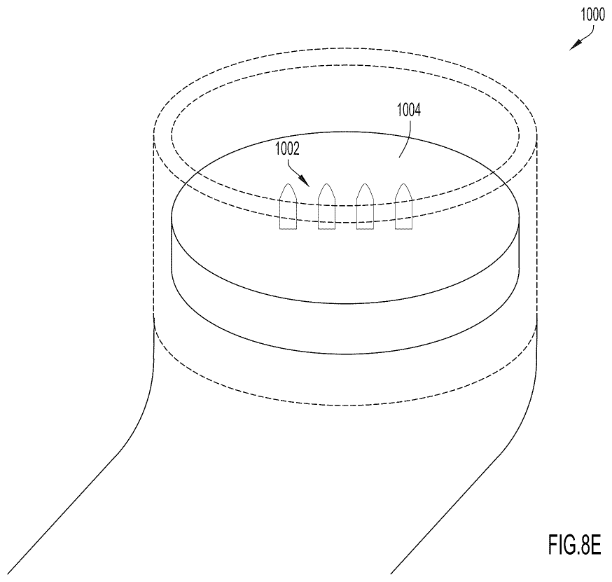

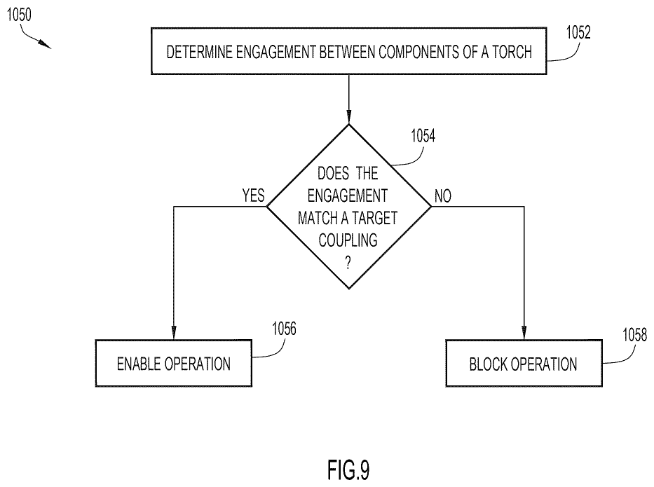

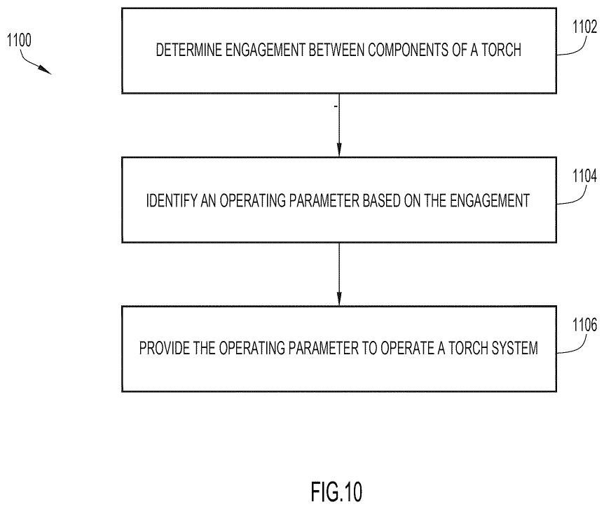

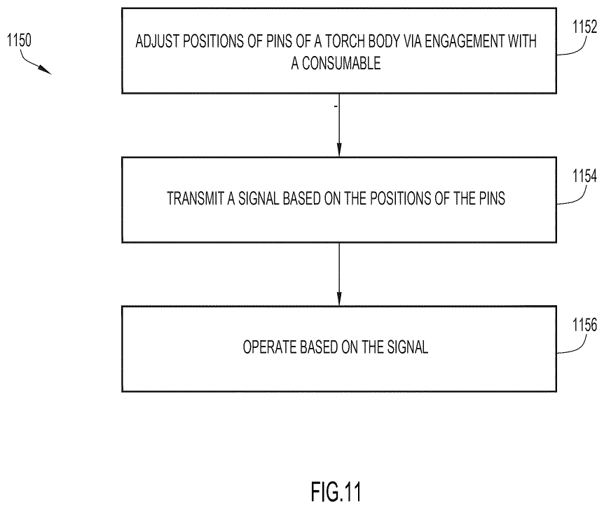

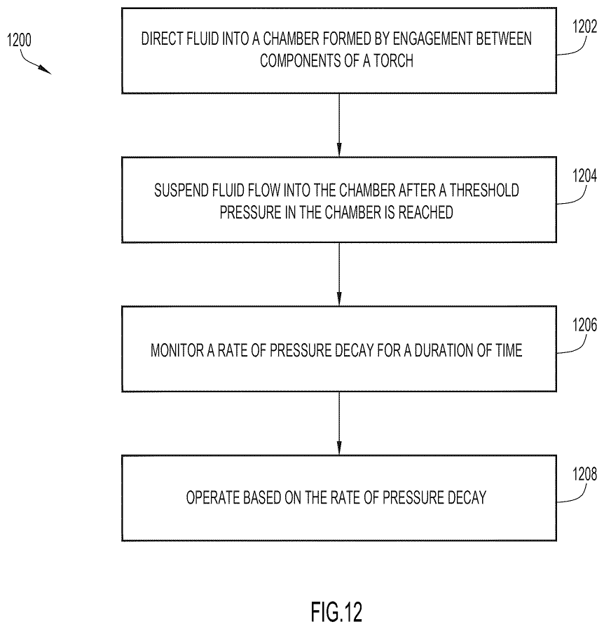

Other components of the torch may additionally or alternatively engage with one another via extensions and apertures to form chambers configured to receive fluid, and pressure decay within the chambers may be determined to identify the other components of the torch. As an example, any of the techniques discussed herein with respect to physical formations may be used to identify a torch body. To illustrate an example embodiment, FIG. 8A is a top perspective view of a torch body 850 with a proximal surface 852 and extensions 854 (e.g., embossment) extending from the proximal surface 852. For example, the extensions 854 may provide a Braille marking, trademark, or other feature that can also be visually observed by a user to ascertain a meaning provided by the extensions 854.

FIG. 8B is a perspective view of a torch mount 900 configured to couple to the torch body 850. As an example, the torch mount 900 may be a part of a power supply, such as at a distal portion of a conduit (e.g., a gas conduit) of the power supply. The torch mount 900 includes a sidewall 902 circumferentially surrounding and defining an opening 904, as well as a surface 906 positioned within the opening 904. Apertures 908 are formed into the surface 906 (e.g., via drilling, milling, and/or any other suitable machining technique). The torch body 850 is configured to insert into the opening 904 to engage the proximal surface 852 of the torch body 850 with the surface 906 of the torch mount 900, and the apertures 908 are configured to receive the extensions 854 of the torch body 850 upon engagement between the proximal surface 852 of the torch body 850 and the surface 906 of the torch mount 900 to form chambers. A fluid may be directed into the chambers to fill and pressurize the chambers, and a pressure decay of the chambers or other parameter indicative of leakage of fluid from the chambers may be determined to identify the engagement between the torch body 850 and the torch mount 900, as well as an identity of the torch body 850 indicated by the engagement. By way of example, the torch mount 900 may be configured to direct plasma gas from a power supply to the torch body 850 for generating an arc, and at least a portion of the plasma gas is directed into the chambers.

FIG. 8C is a schematic diagram of a portion of the torch body 850 coupled to a portion of the torch mount 900 such that the surface 906 of the torch mount 900 engages with the proximal surface 852 of the torch body 850 and the extensions 854 of the torch body 850 are positioned within the apertures 908 of the torch mount 900 in an assembled configuration. Similar to the arrangement of the extensions 658 and apertures 624 of the consumable 650 and torch body 600, respectively, a torch body 850 with desirably formed extensions 854 provides at least a partial seal of the apertures 908. Specifically, the torch mount 900 includes side surfaces 920 extending from the surface 906, as well as back surfaces 922 extending from the side surface 920. While the torch mount 900 is engaged with the torch body 850 in the assembled configuration, the surface 906 of the torch mount 900 engages with the proximal surface 852 of the torch body 850 such that the surface 906, the side surfaces 920, and the back surfaces 922 of the torch mount 900 and the proximal surface 852 of the torch body 850 cooperatively form respective chambers 924. Additionally, openings 926 are formed through each back surface 922 and/or through the side surfaces 920 such that the chambers 924 are fluidly coupled to an interior 928 of the torch mount 900. A fluid source 930 is configured to direct fluid (e.g., plasma fluid for generating an arc, a dedicated fluid) into the interior 928 of the torch body 850 and then into the chambers 924 in a flow direction 932.

In the assembled configuration, the extensions 854 of the torch body 850 extend into the chambers 924. By way of example, the extensions 854 may contact the back surfaces 922 and/or the side surfaces 920 of the torch body 850 and/or the proximal surface 852 from which the extensions 854 extend may contact the surface 906 of the torch mount 900 to provide a partially or fully sealed engagement between the torch mount 900 and the torch body 850. The sealed engagement between the extensions 854 of the torch body 850 and the apertures 908 reduces fluid flow out of the chamber 924. Therefore, a pressure within chambers 924 caused by fluid flow buildup in the chambers 924 is maintained. Indeed, the pressure decay in the illustrated configuration may be relatively lower than a pressure decay of a configuration in which an incompatible or other undesirable torch body arrangement (e.g., that does not include extensions 854 or other physical formations that provide a sealed engagement with the apertures 908) is coupled to the torch mount 900. In embodiments with a full seal, pressure may dissipate through a vent 934 (e.g., atmospheric vent) that is upstream of the mating point between the torch mount 900 and torch body 850, such as within the torch mount 900. A sensor 936 monitors the pressure decay for identifying the torch body 850 and operating the torch accordingly. For example, the pressure decay exceeding a threshold rate may indicate that the torch body 850 is incompatible to the torch mount 900, and operation of the torch may be suspended or blocked to avoid operating with an incompatible torch body 850.

In some embodiments, the proximal surface 852 of the torch body 850 is textured to adjust engagement with the torch mount 900, such as to change a surface area that is in contact with the surface 906 of the torch mount 900 to provide different chambers 924 with different pressure decays. In additional or alternative embodiments, the extensions 854 of the torch body 850 may be differently sized to provide different seals with the apertures 908 of the torch mount 900. In either case, each chamber 924 may have a different rate of pressure decay to help determine the torch body embodiment more granularly. In further embodiments, extensions 854 of the torch body 850 may have different textures to indicate the identity of the torch body 850.

It should also be noted that in some embodiments, the torch body includes apertures, and the torch mount includes extensions configured to extend into the apertures. FIG. 8D is a top perspective view of a torch body 950 with apertures 952 formed into a proximal surface 954. FIG. 8E is a bottom perspective view of a torch mount 1000 with extensions 1002 formed on a surface 1004. Engagement of the torch body 950 with the torch mount 1000 positions the extensions 1002 within the apertures 952 to form chambers, and a fluid may be directed (e.g., via a conduit coupled to the torch mount) into the chambers to pressurize the chambers. Pressure decay within the chambers is then monitored to identify the embodiment of the torch body 950 (e.g., to determine whether the torch body 950 has suitably sized apertures 952 that are sufficiently sealed while engaged with the extensions 1002 of the torch mount 1000).

Each of FIGS. 9-12 discussed below illustrates a respective method for operating a torch or torch system. In some embodiments, the operation of each method is performed by a single entity (e.g., the same control system). In additional or alternative embodiments, different entities (e.g., the first control system 168 of the power supply 154, the second control system 170 of the torch body 156) are configured to perform different operations of the methods. It should be noted that each method may be performed differently than depicted. For example, an additional operation may be performed for any of the methods, an operation of any of the methods may be performed differently than depicted, operations of any of the methods may be performed in a different order, and/or an operation of any of the methods may not be performed. Furthermore, the operations of different methods may be performed in any suitable manner with respect to one another, such as concurrently and/or sequentially (e.g., in response to one another).

FIG. 9 is a flowchart of an embodiment of a method 1050 for enabling of blocking operation of a torch system. At block 1052, engagement between components of the system torch is determined. At block 1054, the engagement is compared to a target engagement, which is associated with an expected engagement provided by a compatible components. In response to a determination that the engagement matches the target engagement, thereby indicating that compatible components are coupled to one another, operation of the torch system is enabled, as indicated in block 1056. However, in response to a determination that the engagement does not match the target engagement, thereby indicating that an incompatible component may be implemented in the torch system and/or that a compatible component is not adequately or desirably implemented in the torch system (e.g., a torch body is not fully inserted into a consumable), operation of the torch system is blocked, as indicated in block 1058. For instance, operation of the torch system may be blocked from initiating, operation of the torch system may be suspended, and/or the torch system may be limited to a low level of operation to avoid negatively affecting operation and/or structural integrity of the torch system (e.g., of a torch body) that otherwise may be caused by operating the torch system while a component is undesirably implemented in the torch system.

In some embodiments, the provided engagement is based on a physical formation of a component of the torch system. The physical formation may include circumferential bands of a consumable, the circumferential bands being radially offset from one another and/or offset from one another along an axis of extension of the consumable, and the arrangement (e.g., size, offset amount, concentricity) of the circumferential bands may be used to determine the engagement of the consumable with a torch body. In additional or alternative embodiments, the physical formation may include an extension of the consumable, the extension having a particular shape (e.g., a particular cross-sectional profile) configured to extend into a receptacle of the torch body, and the insertion or lack thereof of the extension into the receptacle indicates the engagement of the consumable with the torch body. In further embodiments, the physical formation may include extensions of the consumable, the extension being configured to engage with certain parts of the torch body. Such parts may include pins that are configured to translate or otherwise move upon contacting the extensions such that the positioning of the pins indicates the engagement of the consumable with the torch body. Additionally or alternatively, the physical formation may include extensions that are configured to extend within apertures to provide a chamber configured to receive a fluid flow to increase a pressure within the chamber, and pressure decay of the chamber after fluid flow into the chamber is suspended indicates the engagement.

FIG. 10 is a flowchart of a method 1100 to operate a torch system according to an operating parameter. At block 1102, engagement between components of the torch system is determined. At block 1104, an operating parameter is identified based on the engagement. For instance, the engagement may indicate a torch body embodiment that is coupled to a power supply and/or a consumable embodiment that is coupled to the torch body, and the operating parameter is suitable for the particular torch body embodiment and/or consumable embodiment. At block 1106, the operating parameter is established and provided to operate the torch system.

In certain embodiments, the engagement of the components with one another is based on a physical feature of a portion (e.g., a physical formation) of one of the components. For instance, the operating parameter may be identified and provided based on a profile or texture of a surface of the component (e.g., a surface of a consumable that engages with a torch body). In embodiments in which pins of the torch body are moved as a result of contact with the physical formation of the extension, the operating parameter may be identified and provided based on the particular positioning/movement of the pins. In embodiments in which the components engage to form a chamber, the operating parameter may be identified and provided based on a particular rate of pressure decay within the chamber. By providing the operating parameter based on engagement between components, different operating parameters may be suitably provided for different torch body embodiments and/or consumable embodiments (e.g., having different physical formations to provide a particular engagement between components). Thus, operation of the torch system according to the operating parameter is more suitably performed based on the particular torch body embodiment and/or consumable embodiment.

FIG. 11 is a flowchart of an embodiment of a method 1150 for operating a torch system using movable pins of a torch body. As an example, the pins of the torch body may be configured to translate into and out of a surface of the torch body. For instance, a biasing member of the torch body may urge movement of the pins away from the surface, and a sufficient force counteracting the biasing member may move the pins toward the surface. At block 1152, the positions of the pins of the torch body are adjusted via engagement with a consumable. By way of example, the consumable may include a physical formation (e.g., extensions) that are configured to contact and therefore move certain pins of the torch body (e.g., by counteracting the force imparted by the biasing member). Because different consumable embodiments may have different physical formations that contact different pins, different consumable embodiments may move different pins to different positions.

At block 1154, a signal is transmitted based on the position of the pins. For example, a signal may be generated based on the resistance of the resistor. The resistance of the resistor changes as a result of changes in position of the pins. Consequently, movement of the pins adjusts the resistance of the resistor to therefore change the signal generated based on the resistance of the resistor. Accordingly, the signal being transmitted is indicative of the positioning of the pins, which is further indicative of the consumable embodiment (e.g., having a particular physical formation effectuating the positioning of the pins) engaged with the torch body. Further operations are then performed based on the signal, as indicated at block 1156. For example, in response to the signal indicating a consumable is desirably engaged with the torch body (e.g., to move the pins into positions that generate a target signal), operation of the torch system may be initiated or maintained. However, in response to the signal indicating a consumable is not desirably engaged with the torch body (e.g., the pins are not moved into positions that generate a target signal), operation of the torch system may be blocked, suspended, and/or initiated at a lower level. In certain embodiments, an operating parameter is provided based on the signal. For instance, different signals corresponding to different consumable embodiments and different operating parameters may be generated based on the various positioning of the pins. Therefore, a particular signal that indicates a particular consumable embodiment is engaged with the torch body causes an operating parameter suitable for operating the particular consumable embodiment to be provided.

In some embodiments, the method 1150 is performed while the engagement of the torch body with the consumable (e.g., while the torch body is fully engaged with the consumable) in the assembled configuration is maintained such that the positioning of the pins is maintained. Thus, the resistance of the resistor effectuated by the positioning of the pins may be stable to cause a constant signal to be generated and transmitted. In additional or alternative embodiments, the method 1150 is performed while the torch body is in the process of being engaged with the consumable. For instance, during the process in which the torch body is being engaged with the consumable, the pins may be moved to different positioned over time (e.g., as the physical formation of the consumable passes over and contacts different pins). Thus, the signal being transmitted as a result of the varying positioning of the pins may also change over time. In such embodiments, the resistance of the resistor effectuated by the positioning of the pins may change over the duration in which the torch body is being engaged with the consumable, thereby adjusting the signal being generated and transmitted over the duration of time. Thus, the change in the signal over the duration of time may be used to operate the torch system (e.g., based on the sequence of signals being provided matching a threshold sequence).

FIG. 12 is a flowchart of an embodiment of a method 1200 for operating a torch system based on pressure decay within chambers formed by engagement between components of a torch. As an example, a first component (e.g., a torch body) may be configured to engage with a second component (e.g., a torch mount). The first component includes a first surface and extension extending from the surface, and the second component includes a second surface and an aperture formed into the second surface. Engagement of the first component with the second component inserts the extension into the aperture and causes the first surface of the first component to contact the second surface of the second component. Consequently, the first surface, the second surface, and the aperture cooperatively define a chamber in which the extension is positioned.

At block 1202, fluid is directed into the chamber. For instance, an opening may be formed through the second component to fluidly couple the chamber to the interior of the second component. Further, a fluid source is configured to direct fluid into the interior of the second component via a conduit. The fluid then flows from within the interior of the second component into the chamber.

At block 1204, fluid flow into the chamber is suspended after a threshold pressure (e.g., a higher threshold pressure) in the chamber is reached. That is, the fluid source continues to operate to direct fluid into the interior of the second component via the conduit to allow fluid to flow into and buildup within the chamber. A sensor is used to monitor the pressure within the chamber, as caused by fluid buildup within the chamber. After the threshold pressure in the chamber is reached, as determined by the sensor, operation of the fluid source is suspended to avoid further buildup of fluid within the chamber that otherwise would increase the pressure within the chamber (e.g., beyond the threshold pressure). Additionally or alternatively, a valve (e.g., an on-off valve) disposed along the conduit is closed to block fluid flow from the fluid source into the chamber and/or from the chamber toward the fluid source. Thus, fluid (e.g., pressurized fluid within the chamber) is forced to flow out of the chamber via the aperture (e.g., between the first surface of the first component and the second surface of the second component) and/or a vent fluidly coupled to the interior of the second component. As a result, pressure within the chamber begins to decay.

At block 1206, the rate of pressure decay in the chamber or other parameter indicative of fluid flow out of the chamber (e.g., fluid leakage rate) is monitored by the sensor for a duration of time (e.g., until the pressure reaches a lower threshold pressure). The rate of pressure decay (e.g., the duration of time for the pressure to reach the lower threshold pressure) indicates engagement between the components. As an example, an increased surface area of contact between the components (e.g., between the first surface of the first component and the second surface of the second component, between the extension of the first component and the second component) may help block fluid flow out of the chamber to limit the rate of pressure decay, whereas a reduced surface area of contact between the components may allow for greater fluid flow out of the chamber to increase the rate of pressure decay.

At block 1208, an operation is performed based on the rate of pressure decay. For instance, a desirable torch body embodiment may provide a particular engagement (e.g., a particular amount of surface area of contact) with the torch mount to provide an expected or threshold rate of pressure decay. Thus, the monitored rate of pressure decay is compared to the expected rate of pressure decay (e.g., an expected duration of time for the pressure to reach the lower threshold pressure) to determine whether a desirable torch body embodiment is engaged with the torch mount. Based on a difference between the monitored rate of pressure decay and the expected rate of pressure decay exceeding a threshold, thereby indicating a desirable torch body embodiment may not be engaged with the torch mount, operation of the torch system is blocked, suspended, and/or initiated at a lower level. However, based on the difference between the monitored rate of pressure decay and the expected rate of pressure decay being below a threshold (i.e., the monitored rate of pressure decay substantially matches the expected rate of pressure decay), thereby indicating that a desirable torch body embodiment may be engaged with the torch mount, operation of the torch system is enabled or maintained. In certain embodiments, an operating parameter is provided based on the rate of pressure decay. As an example, different torch body embodiments may include different physical formations (e.g., a different texture of the surface, a different arrangement of the extension) to provide engagements between components to adjust the rate of pressure decay. Each torch body embodiment may also be associated with a different operating parameter. As such, the different rates of pressure decays may indicate a different operating parameter to be provided to operate the corresponding torch body embodiment more suitably.

While this application has described the techniques presented herein in detail and with reference to specific embodiments thereof, it is nevertheless not intended to be limited to the details shown, since it will be apparent that various modifications and structural changes may be made therein without departing from the scope of the disclosure and within the scope and range of equivalents of the claims. In addition, various features from one of the embodiments may be incorporated into another of the embodiments. Accordingly, it is appropriate that the appended claims be construed broadly and in a manner consistent with the scope of the disclosure as set forth in the following claims.

Finally, it is intended that the present disclosure cover the modifications and variations of this disclosure that come within the scope of the appended claims and their equivalents. For example, it is to be understood that terms such as “left,” “right,” “top,” “bottom,” “front,” “rear,” “side,” “height,” “length,” “width,” “upper,” “lower,” “interior,” “exterior,” “inner,” “outer” and the like as may be used herein, merely describe points of reference and do not limit the present disclosure to any particular orientation or configuration. Further, the term “exemplary” is used herein to describe an example or illustration. Any embodiment described herein as exemplary is not to be construed as a preferred or advantageous embodiment, but rather as one example or illustration of a possible embodiment of the disclosure.

Similarly, when used herein, the term “comprises” and its derivations (such as “comprising”, etc.) should not be understood in an excluding sense, that is, these terms should not be interpreted as excluding the possibility that what is described and defined may include further elements, steps, etc. Meanwhile, when used herein, the term “approximately” and terms of its family (such as “approximate”, etc.) should be understood as indicating values very near to those which accompany the aforementioned term. That is to say, a deviation within reasonable limits from an exact value should be accepted, because a skilled person in the art will understand that such a deviation from the values indicated is inevitable due to measurement inaccuracies, etc. The same applies to the terms “about” and “around” and “substantially”. Finally, for the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

What is claimed is:

1. A torch system, comprising:
a torch mount configured to engage with a torch body to form a chamber therebetween in an assembled configuration of the torch system;
a conduit configured to direct fluid into the chamber; and
a processor configured to:
monitor a pressure in the chamber; and
transmit a signal in response to determining a difference between a rate of decrease of the pressure in the chamber and an expected rate is above a threshold.

2. The torch system of claim 1, wherein the torch mount comprises a plurality of surfaces that cooperatively define an aperture configured to receive a physical formation of the torch body, a surface of the plurality of surfaces of the torch mount and a proximal surface of the torch body are configured to engage with one another in the assembled configuration, and the plurality of surfaces of the torch mount and the proximal surface of the torch body cooperatively form the chamber.

3. The torch system of claim 2, wherein the surface or a side surface extending from the surface of the plurality of surfaces includes an opening, and the conduit is fluidly coupled to the chamber via the opening.

4. The torch system of claim 1, wherein the torch mount is configured to direct plasma gas to the torch body to generate an arc, and the conduit is configured to direct a portion of the plasma gas as the fluid into the chamber formed between the torch mount and the torch body.

5. The torch system of claim 1, wherein the torch mount is configured to direct plasma gas to the torch body to generate an arc, and the torch system comprises a fluid source configured to direct the fluid into the chamber, the fluid being separate from the plasma gas.

6. The torch system of claim 1, wherein the conduit is configured to direct the fluid into the chamber for a first duration of time to increase the pressure in the chamber to a threshold pressure, the processor is configured to suspend fluid flow into the chamber for a second duration of time after the first duration of time to cause the pressure in the chamber to decrease for the second duration of time, and the processor is configured to monitor the pressure in the chamber during the second duration of time.

7. The torch system of claim 1, wherein the processor is configured to provide an operating parameter for operating the torch system based on the rate of decrease of the pressure in the chamber.

8. A non-transitory, computer-readable medium comprising instructions that, when executed by one or more processors, are configured to cause the one or more processors to:
monitor a pressure within a chamber formed by engagement between a torch body and a consumable of a torch system;
compare a rate of decrease of the pressure to a target rate; and
transmit a signal in response to determining a difference between the rate of decrease of the pressure and the target rate is above a threshold.

9. The non-transitory, computer-readable medium of claim 8, wherein the instructions, when executed by one or more processors, are configured to cause the one or more processors to transmit the signal to suspend operation of the torch system in response to determining the difference between the rate of decrease of the pressure and the target rate is above the threshold.

10. The non-transitory, computer-readable medium of claim 8, wherein the instructions, when executed by one or more processors, are configured to cause the one or more processors to transmit an additional signal to operate the torch system in response to determining the difference between the rate of decrease of the pressure and the target rate is not above the threshold.

11. The non-transitory, computer-readable medium of claim 10, wherein the instructions, when executed by one or more processors, are configured to cause the one or more processors to transmit the additional signal to provide an operating parameter for operating the torch system based on the rate of decrease of the pressure.

12. The non-transitory, computer-readable medium of claim 8, wherein the instructions, when executed by one or more processors, are configured to cause the one or more processors to:
direct fluid into the chamber to increase the pressure within the chamber to a threshold pressure; and
suspend fluid flow into the chamber upon the pressure within the chamber reaching the threshold pressure such that the pressure decreases from the threshold pressure.

13. The non-transitory, computer-readable medium of claim 8, wherein the instructions, when executed by one or more processors, are configured to cause the one or more processors to:
identify a physical formation of the consumable; and
transmit an additional signal based on the physical formation of the consumable.

14. The non-transitory, computer-readable medium of claim 13, wherein the instructions, when executed by one or more processors, are configured to cause the one or more processors to transmit the additional signal to provide an operating parameter for operating the torch system.

15. A torch assembly, comprising:
a torch body configured to engage with a consumable, wherein the torch body comprises a plurality of pins, and a subset of the plurality of pins is configured to translate upon engagement with a physical formation of the consumable; and
a processor configured to transmit a signal based on a position of the plurality of pins caused by engagement of the torch body with the consumable.

16. The torch assembly of claim 15, wherein the processor is configured to transmit the signal to initiate torch operation based on the position of each pin of the plurality of pins matching a target position.

17. The torch assembly of claim 15, wherein the processor is configured to transmit the signal to block torch operation based on a mismatch between the position of a pin of the plurality of pins and a target position.

18. The torch assembly of claim 15, comprising a resistor, wherein the processor is configured to generate the signal via a resistance of the resistor, and translation of the plurality of pins changes the resistance of the resistor to adjust the signal being generated.

19. The torch assembly of claim 15, wherein the processor is configured to transmit the signal to provide an operating parameter based on the position of the plurality of pins caused by engagement of the torch body with the consumable.

20. The torch assembly of claim 15, wherein the processor is configured to transmit the signal based on a sequence in which the subset of the plurality of pins translate during engagement with the physical formation of the consumable.
